(19) United States
(12) Patent Application Publication
(10) Pub. No.: US 2025/0118117 A1
(43) Pub. Date: Apr. 10, 2025

(54) VEHICLE SAFETY MONITORING SYSTEM BASED ON INTERNET OF THINGS

(71) Applicant: THE THIRD RESEARCH INSTITUTE OF MINISTRY OF PUBLIC SECURITY, Shanghai (CN)

(72) Inventor: Caixia Liu, Shanghai (CN)

(21) Appl. No.: 18/832,006

(22) PCT Filed: Nov. 4, 2022
(86) PCT No.: PCT/CN2022/129886

§ 371 Date: Jul. 22, 2024

(30) Foreign Application Priority Data
Jun. 7, 2022 (CN) 202210640837.7

(51) Int. Cl. G07C 5/08; G07C 5/00

(52) U.S. Cl. CPC G07C 5/0808; G07C 5/006; G07C 5/008; G07C 5/0816

(57) ABSTRACT

The present invention discloses a vehicle safety monitoring system. The system includes a tire pressure real-time monitoring and warning unit as a perception layer of the Internet of Things, a vehicle overheat detection and warning unit and/or an explosion prevention and control unit of a lithium-ion power battery of a new energy vehicle, an on-board gateway unit as a transport layer of the Internet of Things, and an alarm prompt unit and a remote management unit as an application layer of the Internet of Things. When the vehicle is in danger, a driver is provided an acousto-optic warning and alarm or a voice prompt to remind the driver to get off for inspection and processing in time. Through a battery explosion suppression module, the explosion warning and alarm condition of the power battery is automatically handled to prevent occurrences of a traffic safety accident and events.

### CROSS-REFERENCE TO RELATED APPLICATIONS

The present application is a National Stage application of PCT international application: PCT/CN2022/129886, filed on 4 Nov. 2022, the disclosure of which is hereby incorporated by reference in its entirety.

### TECHNICAL FIELD

The present invention relates to vehicle safety technologies, and in particular, to a vehicle safety monitoring technology for a fuel vehicle and a new energy vehicle.

### BACKGROUND

According to relevant data, traffic accidents caused by flat tires account for more than 70% of the total traffic accidents in China, which is a shocking proportion. In the event of a flat tire, there will be casualties, which has become a common feature of such traffic accidents, and the harm is great, ranking in the forefront of the traffic accidents. Besides, factors such as overheating of an engine or a motor of a vehicle, overheating of a differential lock system, and overheating of tires are main culprits leading to spontaneous combustion of a vehicle. Especially in recent years, countries have encouraged the purchase of new energy vehicles, and a plurality of new energy vehicles using lithium-ion batteries as power sources have entered thousands of households and driven on various roads. Vehicle explosions or spontaneous combustion incidents caused by the explosion of lithium-ion power batteries are also common, making automobiles, especially new energy vehicles, a potential source of danger while bringing many conveniences to people's lives.

However, the existing vehicle safety monitoring technology can only monitor single operating state data of the vehicle, such as a tire pressure, an oil a temperature, a voltage, a current, and the like, and cannot realize comprehensive monitoring of a driving state of the vehicle. Moreover, the existing programs monitor independent data information, and the detected data information is only used for display, and cannot effectively conduct comprehensive detection of a vehicle tire blowout, vehicle body overheat, and an explosion of the power battery, and provide timely warning.

It can be seen that how to conduct comprehensive and effective detection of the safety of the vehicle, so as to reduce traffic safety accidents caused by the vehicle tire blowouts, the body overheat, the power battery explosion, the vehicle spontaneous combustion, and the vehicle explosion incidents, and ensure road traffic safety is an urgent problem to be solved in this field.

### SUMMARY

A vehicle safety monitoring solution is required for vehicle safety problems such as a vehicle tire blowout, vehicle body overheat, and an explosion of the power battery, which can easily cause casualties and traffic accidents, the solution is based on principles of early detection and early handling, to effectively prevent traffic safety accidents caused by the vehicle tire blowout, the vehicle body overheat, and the explosion of the power battery, vehicle spontaneous combustion and vehicle explosion incidents, and to eliminate potential safety hazards caused by a vehicle safety factor.

Based on the above, the present invention integrates and applies emerging technologies such as the Internet of Things, cloud computing, edge computing, and artificial intelligence, and studies a vehicle safety monitoring system that can comprehensively monitor the pressure of each tire of the vehicle, the overheating condition of the vehicle, and/or the safety status of the lithium-ion power battery of the new energy vehicle.

The present invention is intended to provide a vehicle safety monitoring system for comprehensively detecting a pressure of each tire of the vehicle, an overheating of the vehicle and/or a safety state of the lithium-ion power battery of the new energy vehicle. The vehicle safety monitoring system can monitor a tire pressure related condition such as a tire leakage, a tire low pressure, and a tire temperature, a vehicle temperature condition such as an engine/motor temperature, a differential lock system temperature, a tire temperature, and/or an exhaust pipe temperature, and a safety status of the lithium-ion power battery of the new energy vehicle such as a cell temperature, a cell deformation, a cell air pressure, a cell leakage, a battery compartment explosive gas type and concentration, a battery compartment ambient temperature, and a battery compartment smoke in real time, so as to realize early detection and warning of the vehicle safety problems. At the same time of the warning, an acousto-optic alarm and a voice prompt are sent to a driver to check and deal with in time, and a power battery explosion warning and alarm condition is automatically dealt with through a battery explosion suppression module, and the like, and a real-time linkage emergency rescue and handling force starts an accident rescue as soon as possible, so as to improve safety of operation of a plurality of fuel vehicles and new energy vehicles, try to prevent a traffic safety accident caused by the tire blowout, the body overheat, the power battery explosion, the vehicle spontaneous combustion incident, and the vehicle explosion incident, gain valuable golden handling time for an emergency rescue, prevent the consequence of the traffic accident or the expansion of the consequence of the spontaneous combustion of the vehicle and the vehicle explosion accident, and ensure the safety of people's lives and property.

In order to achieve the above objective, the present invention provides a vehicle safety monitoring system based on the Internet of Things, including:
a tire pressure real-time monitoring and warning unit, where the tire pressure real-time monitoring and warning unit is associated with an on-board gateway unit and an alarm prompt unit and is associated with a remote management unit through the on-board gateway unit, and the tire pressure real-time monitoring and warning unit is configured to collect all information related to a tire pressure in real time, and based on the collected information, and analyze, directly or in cooperation with the on-board gateway unit, whether a tire leaks, a pressure in the tire, a temperature in the tire, and a risk warning;
a vehicle overheat detection and warning unit, where the vehicle overheat detection and warning unit is associated with the on-board gateway unit and is associated with the alarm prompt unit and the remote management unit through the on-board gateway unit, and the vehicle overheat detection and warning unit is configured to collect temperature information of a component directly related to a vehicle operating state on a current vehicle in real time, and determine, directly or in cooperation with the on-board gateway unit based on the collected information, whether the vehicle is overheated and a risk of explosion or damage exists;
an on-board gateway unit, where the on-board gateway unit is arranged in a vehicle cab, and is respectively associated with the tire pressure real-time monitoring and warning unit, the vehicle overheat detection and warning unit, the alarm prompt unit, and the remote management unit, and a communication channel is established among the units to complete data exchange, and the on-board gateway unit is further configured to complete, in cooperation with the tire pressure real-time monitoring and warning unit and/or the vehicle overheat detection and warning unit, risk warning processing based on the data collected by the corresponding unit;
an alarm prompt unit, where the alarm prompt unit is connected to the on-board gateway unit, and is configured to complete a local alarm on the vehicle and/or complete a remote alarm through the remote management unit associated with the on-board gateway unit; and
a remote management unit, where the remote management unit is deployed in a manner of multi-level linkage, is associated with the on-board gateway unit, and is indirectly associated with the tire pressure real-time monitoring and warning unit, the vehicle overheat detection and warning unit, and the alarm prompt unit through the on-board gateway unit, and is configured to receive a tire pressure alarm and/or a vehicle overheat alarm sent by the on-board gateway unit, and generate emergency response and emergency rescue management information according to requirements of an emergency plan when receiving a high-risk level alarm.

Further, the tire pressure real-time monitoring and warning unit includes:
a tire leakage detection module, a low tire pressure detection module, and a tire temperature monitoring module.

The tire leakage detection module in the tire pressure real-time monitoring and warning unit is configured to obtain real-time information on whether each tire of the vehicle has air leakage condition, and transmit the obtained information to the data storage module of the on-board gateway unit, the edge computing module, or to the remote management unit through the network communication module of the on-board gateway unit.

The low tire pressure detection module is configured to obtain real-time information on the air pressure condition of each tire of the vehicle, and transmit the obtained information to the data storage module of the on-board gateway unit, the edge computing module, or to the remote management unit through the network communication module of the on-board gateway unit.

The tire temperature monitoring module is configured to obtain real-time information on an internal temperature of each tire of the vehicle, and transmit the obtained information to the data storage module of the on-board gateway unit, the edge computing module, or to the remote management unit through the network communication module of the on-board gateway unit.

Further, the tire leakage detection module of the tire pressure real-time monitoring and warning unit includes and is not limited to a tire valve core leakage detection device, a tire pinhole leakage detection device, a tire foreign object detection device, a tire side and inner edge damage detection device, a hub flange deformation detection device, a hub fracture detection device, sensing and transmitting devices corresponding to the hub fracture detection device, and the like.

The tire valve core leakage detection device is configured to collect airflow information near a tire valve core, the tire pinhole leakage detection device is configured to detect whether there is slow air leakage caused by a pinhole on a tire surface, the tire foreign object detection device is configured to monitor whether the tire is punctured into an iron nail, a screw, an iron wire, a glass fragment, a sharp stone, a tile and another foreign object that may cause tire leakage; the tire side and inner edge damage detection device is configured to monitor whether a side and an inner edge of the tire are damaged, the hub flange deformation detection device is configured to monitor a deformation condition of a hub flange, and the hub fracture detection device is configured to monitor whether a vehicle hub bursts.

Further, the low tire pressure detection module of the tire pressure real-time monitoring and warning unit includes a direct tire pressure monitoring device and an indirect tire pressure monitoring device and sensing and transmitting devices corresponding to the direct tire pressure monitoring device and the indirect tire pressure monitoring device.

The direct tire pressure monitoring device is configured to collect real-time pressure value information in the tire, and intuitively determine whether the tire is in a low-pressure state; and
the indirect tire pressure monitoring device is configured to collect a real-time speed difference of different tires of the vehicle, and determine consistency of rolling radii of wheels through the speed difference, so as to determine whether a tire is in a low-pressure state.

Further, the tire temperature monitoring module of the tire pressure real-time monitoring and warning unit includes a temperature sensing and monitoring device in each tire and a corresponding sensing and transmitting device.

The temperature sensing and monitoring device is configured to obtain real-time information on an internal temperature condition of each tire of the vehicle, and determine whether there is a risk of tire blowout through the temperature and the air pressure. Generally, the temperature sensing and monitoring device can be deployed in conjunction with the tire pressure detection device of the tire, such as use of an integrated pressure temperature sensor.

Further, the tire pressure real-time monitoring and warning unit is directly associated with the on-board gateway unit, and is indirectly associated with the vehicle alarm prompt unit and the remote management unit through the on-board gateway unit. The tire leakage detection module, the low tire pressure detection module, and the plurality of detection devices of the tire temperature monitoring module of the tire pressure real-time monitoring and warning unit send the detection information to the network communication module of the on-board gateway unit through the corresponding sensing and transmitting device, aggregate the detection data to the data storage module of the on-board gateway unit, and perform an intelligent analysis through the edge computing module of the on-board gateway unit. When the air leakage, the deformation, or the temperature analysis result of the corresponding detection object triggers real-time monitoring and warning of the tire leakage, the low tire pressure, or the tire burst, the network communication module of the on-board gateway unit sends a corresponding acousto-optic alarm or a voice prompt to the alarm prompt unit, and at the same time uploads the alarm prompt information to the remote management unit through the network communication module of the on-board gateway unit.

Further, the vehicle overheat detection and warning unit includes:
an engine/motor temperature monitoring module, a differential lock system temperature monitoring module, a tire temperature monitoring module, and/or an exhaust pipe temperature monitoring module.

Further, the engine/motor temperature monitoring module in the vehicle overheat detection and warning unit is configured to obtain real-time temperature of the vehicle engine/motor (obtain engine temperature for a fuel-powered vehicle; and obtain motor temperature for a new energy vehicle) information, and transmit the obtained information to the data storage module of the on-board gateway unit, the edge computing module, or to the remote management unit through the network communication module of the on-board gateway unit.

Further, the differential lock system temperature monitoring module in the vehicle overheat detection and warning unit is configured to obtain real-time temperature information of the vehicle differential lock system, and transmit the obtained information to the data storage module of the on-board gateway unit, the edge computing module, or to the remote management unit through the network communication module of the on-board gateway unit.

Further, the tire temperature monitoring module in the vehicle overheat detection and warning unit is configured to obtain real-time temperature information of the vehicle tire, and transmit the obtained information to the data storage module of the on-board gateway unit, the edge computing module, or to the remote management unit through the network communication module of the on-board gateway unit.

Further, the exhaust pipe temperature monitoring module in the vehicle overheat detection and warning unit is configured to obtain real-time temperature information of the exhaust pipe of the fuel vehicle, and transmit the obtained information to the data storage module of the on-board gateway unit, the edge computing module, or to the remote management unit through the network communication module of the on-board gateway unit.

Further, the vehicle overheat detection and warning unit is directly associated with the on-board gateway unit, and is indirectly associated with the vehicle alarm prompt unit and the remote management unit through the on-board gateway unit. The plurality of temperature detection devices of the engine/motor temperature monitoring module, the differential lock system temperature monitoring module, the tire temperature monitoring module, and/or the exhaust pipe temperature monitoring module of the vehicle overheat detection and warning unit converge the detection data to the data storage module of the on-board gateway unit through the network communication module of the on-board gateway unit, and perform an intelligent analysis through the edge computing module of the on-board gateway unit. When the temperature analysis result of the corresponding detection object triggers the vehicle overheat detection and warning, the network communication module of the on-board gateway unit sends a corresponding acousto-optic or a voice prompt to the alarm prompt unit, and at the same time uploads the alarm prompt information to the remote management unit through the network communication module of the on-board gateway unit.

Further, the detection system further includes an explosion prevention and control unit of a lithium-ion power battery of a new energy vehicle. A sensor of the explosion prevention and control unit of the lithium-ion power battery of the new energy vehicle is arranged in a cell of the lithium-ion power battery of the new energy vehicle and in a battery compartment, is associated with the on-board gateway unit, and is associated with the alarm prompt unit and the remote management unit through the on-board gateway unit.

The explosion prevention and control unit of the lithium-ion power battery of the new energy vehicle is configured to collect a cell temperature, a cell deformation, a cell air pressure, a cell leakage condition, a battery compartment explosive gas concentration, a battery compartment ambient temperature, and a battery compartment smoke information of the current vehicle; and determine, through computing directly or in cooperation with the on-board gateway unit based on the collected information, whether there is an explosion risk or a combustion risk in a vehicle power battery, and enable a battery explosion suppression function when determining that a detection information analysis result is higher than a relevant set threshold to trigger a power cell danger or a battery compartment danger alarm.

Further, the explosion prevention and control unit of the lithium-ion power battery of the new energy vehicle includes:
a cell temperature monitoring module, a cell deformation detection module, a cell air pressure monitoring module, a cell liquid leakage detection module, a battery compartment explosive gas detection module, a battery compartment ambient temperature monitoring module, a battery compartment smoke detection module, and a battery explosion suppression module.

The cell temperature monitoring module in the explosion prevention and control unit of the lithium-ion power battery of the new energy vehicle is configured to obtain the real-time temperature information of the cell of the vehicle power battery, and transmit the obtained information to the data storage module of the on-board gateway unit, the edge computing module, or to the remote management unit through the network communication module of the on-board gateway unit.

The cell deformation detection module in the explosion prevention and control unit of the lithium-ion power battery of the new energy vehicle is configured to obtain real-time deformation information of the cell of the vehicle power battery, and transmit the obtained information to the data storage module of the on-board gateway unit, the edge computing module, or to the remote management unit through the network communication module of the on-board gateway unit.

The cell air pressure monitoring module in the explosion prevention and control unit of the lithium-ion power battery of the new energy vehicle is configured to obtain real-time air pressure information of the cell of the vehicle power battery, and transmit the obtained information to the data storage module of the on-board gateway unit, the edge computing module, or to the remote management unit through the network communication module of the on-board gateway unit.

The cell liquid leakage detection module in the explosion prevention and control unit of the lithium-ion power battery of the new energy vehicle is configured to obtain real-time liquid leakage information of the cell of the vehicle power battery, and transmit the obtained information to the data storage module of the on-board gateway unit, the edge computing module, or to the remote management unit through the network communication module of the on-board gateway unit.

The battery compartment explosive gas detection module in the explosion prevention and control unit of the lithium-ion power battery of the new energy vehicle is configured to obtain composition and real-time concentration information of an explosive gas in the vehicle power battery compartment, and transmit the obtained information to the data storage module of the on-board gateway unit, the edge computing module, or to the remote management unit through the network communication module of the on-board gateway unit.

The battery compartment ambient temperature monitoring module in the explosion prevention and control unit of the lithium-ion power battery of the new energy vehicle is configured to obtain ambient temperature information of the vehicle power battery compartment, and transmit the obtained information to the data storage module of the on-board gateway unit, the edge computing module, or to the remote management unit through the network communication module of the on-board gateway unit.

The battery compartment smoke detection module in the explosion prevention and control unit of the lithium-ion power battery of the new energy vehicle is configured to obtain information on whether there is smoke in the vehicle power battery compartment, and transmit the obtained information to the data storage module of the on-board gateway unit, the edge computing module, or to the remote management unit through the network communication module of the on-board gateway unit.

The battery explosion suppression module of the battery compartment in the explosion prevention and control unit of the lithium-ion power battery of the new energy vehicle is configured to cut off power supply or perform fire extinguishing and explosion-proof treatment when the lithium-ion power battery explosion warning information appears.

Further, the cell temperature monitoring module in the explosion prevention and control unit of the lithium-ion power battery of the new energy vehicle includes but is not limited to:
an internal cell temperature sensing and monitoring device and/or an internal cell resistance tomography device and a corresponding sensing and transmitting device.

The internal cell temperature sensing and monitoring device of the cell temperature monitoring module is configured to obtain real-time information on an internal temperature of the lithium-ion power cell of the new energy vehicle, and determine whether the cell has an explosion risk through the temperature; and

The internal cell resistance tomography device of the cell temperature monitoring module is configured to obtain internal resistivity distribution information of the lithium-ion power cell of the new energy vehicle, and determine whether there is a temperature abnormality and an explosion risk in the cell through an internal temperature field and an electric field distribution law of the cell.

Further, the cell deformation detection module in the explosion prevention and control unit of the lithium-ion power battery of the new energy vehicle includes but is not limited to:
an internal deformation sensing and detection device and/or a cell surface variable resistance detection device and a corresponding sensing and transmitting device.

The internal deformation sensing and detection device of the cell deformation detection module is configured to obtain real-time information on the deformation condition of the lithium-ion power cell for the new energy vehicle, and determine whether the cell has a bulging or explosion risk through deformation; and
the cell surface variable resistance detection device of the cell deformation detection module is configured to obtain variable resistance information on the surface of the lithium-ion power cell of the new energy vehicle, and determine whether the deformation occurs in the cell and whether there is an explosion risk by the law that the variable resistance increases with an increase of the battery deformation.

Further, the cell air pressure monitoring module in the explosion prevention and control unit of the lithium-ion power battery of the new energy vehicle includes but is not limited to:
an internal air pressure monitoring device and a corresponding sensing and transmitting device.

The internal air pressure monitoring device of the cell air pressure monitoring module is configured to obtain real-time information on the air pressure inside the lithium-ion power cell of the new energy vehicle, and determine whether the cell has an explosion risk through the air pressure.

Further, the cell liquid leakage detection module in the explosion prevention and control unit of the lithium-ion power battery of the new energy vehicle includes but is not limited to:
a battery bus insulation impedance detection device and/or a battery positive and negative bus current detection device and/or a VOC detection device and a corresponding sensing and transmitting device.

The battery bus insulation impedance detection device of the cell liquid leakage detection module is configured to obtain real-time information of insulation impedance of the single bus of the lithium-ion power battery of the new energy vehicle, and determine whether the cell has the risk of liquid leakage through fluctuation of the insulation impedance.

The battery positive and negative bus current detection device of the cell liquid leakage detection module is configured to obtain current balance on the positive and negative bus of the lithium-ion power cell of the new energy vehicle, and determine whether the cell has liquid leakage through the current short circuit condition.

The VOC detection device of the cell liquid leakage detection module is configured to obtain an organic volatile component of the leakage of the lithium-ion power battery monomer of the new energy vehicle, and determine whether there is leakage of a battery monomer through a specific gas component and a corresponding concentration.

Further, the battery compartment explosive gas detection module in the explosion prevention and control unit of the lithium-ion power battery of the new energy vehicle includes but is not limited to:
a CO explosive gas detection, sensing, and detection device, an H₂ explosive gas detection, sensing, and detection device, a CH₄ explosive gas detection, sensing, and detection device, a VOC detection device, and a corresponding sensing and transmitting device.

The CO explosive gas detection, sensing, and detection device in the battery compartment explosive gas detection module is configured to obtain real-time information on whether there is CO and a gas concentration in the lithium-ion power battery compartment of the new energy vehicle, and determine whether the CO in the battery compartment reaches an upper and lower explosion limit through the detection result.

The H₂ explosive gas detection, sensing, and detection device in the battery compartment explosive gas detection module is configured to obtain real-time information on whether there is H₂ and a gas concentration in the lithium-ion power battery compartment of the new energy vehicle, and determine whether the H₂ in the battery compartment reaches an upper and lower explosion limit through the detection result.

The CH₄ explosive gas detection, sensing, and detection device in the battery compartment explosive gas detection module is configured to obtain real-time information on whether there is CH₄ and a gas concentration in the lithium-ion power battery compartment of the new energy vehicle, and determine whether the CH₄ in the battery compartment reaches an upper and lower explosion limit through the detection result.

The VOC detection device in the battery compartment explosive gas detection module is configured to obtain real-time information on whether there is CO, and the like and the corresponding gas concentration in the lithium-ion power battery compartment of the new energy vehicle, and determine whether the CO and other gases in the battery compartment reach the upper and lower explosion limit through the detection result.

Further, the battery compartment ambient temperature monitoring module in the explosion prevention and control unit of the lithium-ion power battery of the new energy vehicle includes but is not limited to:
a temperature sensing and monitoring device in the battery compartment and a corresponding sensing and transmitting device.

The battery compartment temperature sensing and monitoring device of the battery compartment ambient temperature monitoring module is configured to obtain real-time information on an internal temperature of the lithium-ion power battery compartment of the new energy vehicle, and determine whether a battery pack has an explosion risk through the temperature.

Further, the battery compartment smoke detection module in the explosion prevention and control unit of the lithium-ion power battery of the new energy vehicle includes but is not limited to:
an ion smoke detector, a photoelectric smoke detector, an infrared beam smoke detector, a video analytical smoke detector, a photosensitive fire detector, and a video analysis smoke detector and a corresponding sensing and transmitting device.

The ion smoke detector, the photoelectric smoke detector, the infrared beam smoke detector, and the video analytical smoke detector of the battery compartment smoke detection module is configured to obtain real-time information on the smoke condition inside the lithium-ion power battery compartment of the new energy vehicle, and determine whether the battery pack has the risk of fire, combustion, or explosion through the smoke condition.

The photosensitive fire detector and the video analysis smoke detector of the battery compartment smoke detection module is configured to obtain real-time information on a flame condition inside the lithium-ion power battery compartment of the new energy vehicle, and determine whether the battery pack is at risk of fire, combustion, or explosion through the flame condition.

Further, the battery explosion suppression module in the explosion prevention and control unit of the lithium-ion power battery of the new energy vehicle includes but is not limited to:
a circuit controller and/or an intelligent circuit breaker and/or a lithium-ion battery compartment fire suppression device, and/or an automatic fire extinguishing linkage control device, and the like.

The circuit controller of the battery explosion suppression module is configured to receive circuit control information sent by the remote management unit forwarded by the on-board gateway unit, and cut off a power battery power supply line.

The intelligent circuit breaker of the battery explosion suppression module is configured to automatically cut off the power battery power supply line when there is an explosion warning of the lithium-ion power battery of the new energy vehicle.

The lithium-ion battery compartment fire suppression device of the battery explosion suppression module is configured to automatically spray and release a fire-extinguishing agent when an explosion warning of the lithium-ion power battery of the new energy vehicle occurs, and to suppress the fire of a lithium-ion power battery box.

The automatic fire extinguishing linkage control device of the battery explosion suppression module is configured to spray a high-efficiency cooling suppressing medium when the explosion warning of the lithium-ion power battery of the new energy vehicle occurs, and to cool and suppress a thermal runaway cell.

Further, the explosion suppression module in the explosion prevention and control unit of the lithium-ion power battery of the new energy vehicle is associated with the on-board gateway unit, and is indirectly associated with the vehicle alarm prompt unit and the remote management unit through the on-board gateway unit. The plurality of sensing and transmitting devices of the cell temperature monitoring module, the cell deformation detection module, the cell air pressure monitoring module, the cell liquid leakage detection module, the battery compartment explosive gas detection module, the battery compartment ambient temperature monitoring module, and the battery compartment smoke detection module in the explosion prevention and control unit of the lithium-ion power battery of the new energy vehicle converge the detection data to the data storage module of the on-board gateway unit through the network communication module of the on-board gateway unit, and perform an intelligent analysis through the edge computing module of the on-board gateway unit. When the detection analysis result of the corresponding detection object triggers an explosion warning of the lithium-ion power battery, the network communication module of the on-board gateway unit sends a corresponding acousto-optic alarm or a voice prompt to the alarm prompt unit, and at the same time uploads the alarm prompt information to the remote management unit through the network communication module of the on-board gateway unit.

Further, the on-board gateway unit includes:
a network communication module and/or a data storage module, and/or an edge computing module.

The network communication module in the on-board gateway unit is used for data exchange between the tire pressure real-time monitoring and warning unit, the vehicle overheat detection and warning unit, the explosion prevention and control unit of a lithium-ion power battery of a new energy vehicle, the alarm prompt unit, and the remote management unit; can transmit the tire pressure real-time monitoring information uploaded by the tire pressure real-time monitoring and warning unit, the overheating detection information of each module of the vehicle, and forward the lithium-ion power cell and the battery compartment detection information and the analysis result of the detection information to the remote management unit; forwards alarm command and voice prompt command information to the alarm prompt unit according to the received remote management unit command, and forward command information such as alarm threshold setting adjustment and circuit control to the relevant detection devices of the tire pressure real-time monitoring and warning unit, the vehicle overheat detection and warning unit, and the explosion prevention and control unit of a lithium-ion power battery of a new energy vehicle.

The data storage module in the on-board gateway unit is configured to store the detection information uploaded by the tire pressure real-time monitoring and warning unit, the vehicle overheat detection and warning unit, the explosion prevention and control unit of the lithium-ion power battery of the new energy vehicle.

The edge computing module in the on-board gateway unit is configured to intelligently analyze and determine the detection information uploaded by the tire pressure real-time monitoring and warning unit, the vehicle overheat detection and warning unit, and the explosion prevention and control unit of the lithium-ion power battery of the new energy vehicle.

Further, the on-board gateway unit is directly associated with the tire pressure real-time monitoring and warning unit, the vehicle overheat detection and warning unit, the explosion prevention and control unit of the lithium-ion power battery of the new energy vehicle, the alarm prompt unit, and the remote management unit. When the on-board gateway unit receives the detection information of the tire pressure real-time monitoring and warning unit, the vehicle overheat detection and warning unit, and the explosion prevention and control unit of the lithium-ion power battery of the new energy vehicle, and analyzes and determines that a related warning alarm such as the tire low pressure, the vehicle overheat, or the lithium-ion power battery explosion is triggered, the on-board gateway unit sends the acousto-optic alarm or the voice prompt information to the alarm prompt unit and sends warning alarm information and the real-time monitoring data information to the remote management unit. When the on-board gateway unit receives an alarm command, a voice prompt command, or an alarm threshold setting adjustment, or circuit control information sent by the remote management unit, the alarm command and the voice prompt command information are sent to the alarm prompt unit, and alarm threshold setting adjustment command information and circuit control command information are sent to the relevant detection device of the tire pressure real-time monitoring and warning unit, the vehicle overheat detection and warning unit, and the explosion prevention and control unit of the lithium-ion power battery of the new energy vehicle, to adjust an alarm threshold of a detection sensor and cut off a circuit of the power battery.

Further, the alarm prompt unit includes:
alarm prompt subunits of the remote detection client software such as an internal cab acousto-optic alarm module, an internal cab voice prompt module, an external cab acousto-optic alarm module, an external cab voice prompt module and alarm and remote monitoring client software alarm prompt subunits such as a government industry management client software, an enterprise operation management client software, a driver and passenger service client software.

Further, the alarm prompt unit is directly associated with the tire pressure real-time monitoring and warning unit, the vehicle overheat detection and warning unit, the explosion prevention and control unit of the lithium-ion power battery of the new energy vehicle, and the on-board gateway unit. When the local alarm prompt subunit receives real-time monitoring and warning information of medium-risk or low-risk tire pressure sent by the on-board gateway unit, the vehicle overheat detection and warning information, and the explosion warning information of the lithium-ion power battery of the new energy vehicle, the alarm prompt unit sends an internal cab acousto-optic alarm and the voice prompt to prompt the driver to stop nearby or stop immediately for inspection. When the local alarm prompt subunit receives the high-risk level tire pressure real-time monitoring and warning information, the vehicle overheat detection and warning information, and the explosion warning information of the lithium-ion power battery of the new energy vehicle, the alarm prompt unit sends internal and external cab acousto-optic alarms and voice prompts to prompt the driver to stop immediately for inspection, prompt passers-by to be alert to an abnormal vehicle, avoid in time, or call the police immediately. When the remote monitoring client software alarm prompt subunit receives real-time monitoring and warning information of medium-risk or low-risk tire pressure, the vehicle overheat detection and warning information, and the explosion warning information of the lithium-ion power battery of the new energy vehicle, the alarm prompt unit sends the alarm and prompt. When the remote monitoring client software alarm prompt subunit receives the high-risk level tire pressure real-time monitoring and warning information, the vehicle overheat detection and warning information, and the explosion warning information of the lithium-ion power battery of the new energy vehicle, the alarm prompt unit sends the emergency alarm and the voice prompt and starts the emergency management process according to the emergency plan by default.

Further, the remote management unit includes:
a government industry management client software, an enterprise operation management client software, a driver and passenger service client software, and a communication center.

The remote management unit of the vehicle safety monitoring system for an operational vehicle includes the above three types of detection client, and the remote management unit of the vehicle safety monitoring system for a private vehicle has at least a public security industry management client in the driver and passenger service client and the government industry management client software.

The government industry management client software in the remote management unit is configured to receive and display high-risk level tire pressure real-time monitoring and warning information, vehicle overheat detection and warning information, and explosion warning information of the lithium-ion power battery of the new energy vehicle forwarded by the tire pressure real-time monitoring and warning unit, the tire pressure real-time monitoring and warning unit, and the explosion prevention and control unit of the lithium-ion power battery of the new energy vehicle through the on-board gateway unit and the communication center, send a relevant management command based on the received warning and alarm information, start an emergency management process, and issue a relevant emergency response command.

the enterprise operation management client software in the remote management unit is configured to: receive and display tire pressure real-time monitoring and warning information, vehicle overheat detection and warning information, and explosion warning information of the lithium-ion power battery of the new energy vehicle forwarded by the tire pressure real-time monitoring and warning unit, the tire pressure real-time monitoring and warning unit, and the explosion prevention and control unit of the lithium-ion power battery of the new energy vehicle through the on-board gateway unit and the communication center, send a relevant management command based on the received warning and alarm information, start the emergency management process, send an emergency alarm to a government industry management client, and issue a relevant emergency response command when high-risk level tire pressure real-time monitoring and warning information, the vehicle overheat detection and warning information, and the explosion warning information of the lithium-ion power battery of the new energy vehicle are received.

The driver and passenger service client software in the remote management unit is configured to: receive and display tire pressure real-time monitoring and warning information, vehicle overheat detection and warning information, and explosion warning information of the lithium-ion power battery of the new energy vehicle forwarded by the tire pressure real-time monitoring and warning unit, the tire pressure real-time monitoring and warning unit, and the explosion prevention and control unit of the lithium-ion power battery of the new energy vehicle through the on-board gateway unit and the communication center, send an acousto-optic alarm, a voice prompt, and an emergency rescue guide corresponding to alarm and warning information based on the received alarm and warning information, to prompt the driver to stop nearby or stop immediately for inspection, and provide a corresponding emergency response guide.

The communication center in the remote management unit is configured to communicate with the on-board gateway unit, receive and store the tire pressure real-time monitoring and warning information, the vehicle overheat detection and warning information, and the explosion warning information of the lithium-ion power battery of the new energy vehicle forwarded by the tire pressure real-time monitoring and warning unit, the tire pressure real-time monitoring and warning unit, and the explosion prevention and control unit of the lithium-ion power battery of the new energy vehicle through the on-board gateway unit, and forward the information to the government industry management client software, the enterprise operation management client software, and the driver and passenger service client software respectively. The communication center also serves as a computer system environment for the government industry management client software, the enterprise operation management client software, and the driver and passenger service client software, and is configured to support a related software application, and forward management commands or response commands of the government industry management client software, the enterprise operation management client software, and the driver and passenger service client software to the on-board gateway unit.

Further, the remote management unit is arranged on a cloud platform of a competent government industry department related to elated to automobile transportation and/or a local storage server and/or a personal hand-held intelligent terminal of a relevant management person, a cloud platform and/or a local storage server of a transport enterprise to which the vehicle belongs and transport-related parties and/or a personal hand-held intelligent terminal of a relevant management person, and a personal hand-held intelligent terminal of a driver and passenger, is connected with the on-board gateway unit. The remote management unit receives the tire pressure real-time monitoring and warning information, the vehicle overheat detection and warning information, the explosion warning information of the lithium-ion power battery of the new energy vehicle and the related detection data information sent by the on-board gateway unit, issues a driver management command based on the alarm information, feeds back to the on-board gateway unit, and feeds back to the alarm prompt unit through the on-board gateway unit. The remote management unit supports setting and adjusting a warning threshold and an information upload frequency of the tire pressure real-time monitoring and warning unit, the tire pressure real-time monitoring and warning unit, and the relevant monitoring device of the explosion prevention and control unit of the lithium-ion power battery of the new energy vehicle through the relevant detection client software.

The vehicle safety monitoring system based on the Internet of Things provided by the present invention can automatically monitor vehicle safety monitoring information. When the vehicle is in danger, a driver is provided an acousto-optic warning and alarm or a voice prompt to remind the driver to get off for inspection and processing in time. Through a battery explosion suppression module, the explosion warning and alarm condition of the power battery is automatically handled to prevent occurrences of a traffic safety accident and events such as vehicle spontaneous combustion and a vehicle explosion caused by a vehicle tire blowout, vehicle body overheat, and an explosion of the power battery.

Moreover, the system not only comprehensively detects and improves the safety of the operation of a plurality of fuel vehicles and new energy vehicles through the vehicle safety elements, but also uploads the vehicle safety monitoring, warning, and alarm information to a vehicle-owned enterprise and competent industry department in real time, and gains valuable golden handling time for an early deployment of emergency rescue and handling force and a rapid start of emergency rescue, which is of great significance to improve the accident emergency response speed and rescue efficiency of the vehicle-owned enterprise and the competent industry department, prevent the consequences of traffic accident or the expansion of the consequences of vehicle spontaneous combustion and vehicle explosion accident, and ensure the safety of people's lives and property.

### BRIEF DESCRIPTION OF THE DRAWINGS

The present invention is further explained below with reference to the accompanying drawings and specific implementations.

FIG. 1 is a schematic diagram of an overall composition principle of a vehicle safety monitoring system based on the Internet of Things according to an example of the present invention.

FIG. 2 is a schematic diagram of a composition principle and a use flow chart of a tire pressure real-time monitoring and warning unit according to an example of the present invention.

FIG. 3 is a schematic diagram of a tire leakage detection module of a tire pressure real-time monitoring and warning unit according to an example of the present invention.

FIG. 4 is a schematic diagram of a composition principle and a use flow chart of a vehicle overheat detection and warning unit according to an example of the present invention.

FIG. 5 is a schematic diagram of a composition principle and a use flow chart of an explosion prevention and control unit of a lithium-ion power battery of a new energy vehicle according to an example of the present invention.

FIG. 6 is a schematic diagram of a composition principle of an on-board gateway unit and a network communication module thereof according to an example of the present invention;

FIG. 7 is a schematic diagram of a composition principle and a use flow chart of an alarm prompt unit according to an example of the present invention;

FIG. 8 is a schematic diagram of a composition principle and a use flow chart of a remote management unit according to an example of the present invention.

FIG. 9 is a schematic diagram of a principle of a composition of a government industry management client of a remote management unit according to an example of the present invention.

FIG. 10 is a schematic diagram of a principle of a composition of an enterprise operation management client of a remote management unit according to an example of the present invention.

FIG. 11 is a schematic diagram of a principle of a composition of a driver and passenger service client of a remote management unit according to an example of the present invention.

FIG. 12 is a schematic diagram of a principle of a composition of a communication center of a remote management unit according to an example of the present invention.

### DETAILED DESCRIPTION

In order to make the technical means, creation features, purpose and efficacy realized by the present invention easy to understand, the present invention is further described below in conjunction with the specific illustrations.

Examples provide a vehicle safety monitoring solution for comprehensively detecting a pressure of each tire of a vehicle, an overheating of the vehicle and/or a safety status of a lithium-ion power battery of a new energy vehicle for vehicle safety problems such as a vehicle tire blowout, vehicle body overheat, and an explosion of the power battery, which can easily cause a traffic accident.

The example integrates and applies emerging technologies such as the Internet of Things, cloud computing, edge computing, and artificial intelligence to specifically form a vehicle safety monitoring system that can comprehensively monitor the pressure of each tire of the vehicle, the overheating condition of the vehicle, and/or the safety status of the lithium-ion power battery of the new energy vehicle.

The vehicle safety monitoring system can monitor a tire pressure related condition such as a tire leakage, a tire low pressure, and a tire temperature, a vehicle temperature condition such as an engine/motor temperature, a differential lock system temperature, a tire temperature, and/or an exhaust pipe temperature, and a safety status of the lithium-ion power battery of the new energy vehicle such as a cell temperature, a cell deformation, a cell air pressure, a cell leakage, a battery compartment explosive gas type and concentration, a battery compartment ambient temperature, and a battery compartment smoke in real time. The system can also analyze the vehicle safety according to the detected data information, so as to realize early detection and warning of the vehicle safety problems. At the same time of the warning, an acousto-optic alarm and a voice prompt are sent to a driver to check and deal with in time, and a power battery explosion warning and alarm condition is automatically dealt with through a battery explosion suppression module, and the like, and a real-time linkage emergency rescue and handling force starts an accident rescue as soon as possible, so as to improve safety of operation of a plurality of fuel vehicles and new energy vehicles, try to prevent a traffic safety accident caused by the tire blowout, the body overheating, the power battery explosion, the vehicle spontaneous combustion incident, and the vehicle explosion incident, gain valuable golden handling time for an emergency rescue, prevent the consequence of the traffic accident or the expansion of the consequence of the spontaneous combustion of the vehicle and the vehicle explosion accident, and ensure the safety of people's lives and property.

FIG. 1 is a schematic diagram of an overall composition principle of a vehicle safety monitoring system based on the Internet of Things according to this example.

Based on FIG. 1, the vehicle safety monitoring system 700 based on the Internet of Things is mainly composed of a tire pressure real-time monitoring and warning unit 100, a vehicle overheat detection and warning unit 200, an explosion prevention and control unit 300 of the lithium-ion power battery of the new energy vehicle, an on-board gateway unit 400, an alarm prompt unit 500, and a remote management unit 600, which are in cooperation with each other.

Based on FIG. 1, in the tire pressure real-time monitoring and warning unit 100 of this system, sensor components are distributed inside and outside each tire of the vehicle or a position of the vehicle body of the tire can be detected, are associated with the on-board gateway unit 400 of the vehicle, and are associated with the alarm prompt unit 500 and the remote management unit 600 through the on-board gateway unit 400.

The tire pressure real-time monitoring and warning unit 100 so distributed can collect tire deformation information, atmospheric pressure information in the tire, and real-time temperature information in the tire of a current vehicle. The tire pressure real-time monitoring and warning unit stores the collected tire deformation information, the atmospheric pressure information inside the tire and the real-time temperature information inside the tire of the vehicle in a data storage module of the on-board gateway unit 400.

Further, the tire pressure real-time monitoring and warning unit 100 can analyze the tire deformation information collected by itself or through an edge computing module of the on-board gateway unit 400 and determine whether the tire leaks or not; analyze the collected atmospheric pressure information in the tire and determines whether the tire is under-pressurized or over-pressurized; and analyze the real-time temperature information collected in the tire and determine whether there is a risk of tire blowout in combination with the atmospheric pressure information in the tire.

Based on the above, when it is determined that a detection information analysis result is higher than a set deformation threshold to trigger an air leakage alarm, lower than a set air pressure threshold to trigger a low pressure alarm, higher than the set air pressure threshold to trigger an overinflation alarm, and lower than the set air pressure threshold and the temperature is higher than a set threshold to trigger a tire blowout warning, a warning or an alarm message is sent to the remote management unit 600 through a network communication module of the on-board gateway unit 400, and at the same time, a corresponding local warning acousto-optic, or voice prompt is sent through the alarm prompt unit to prompt the driver to stop for inspection.

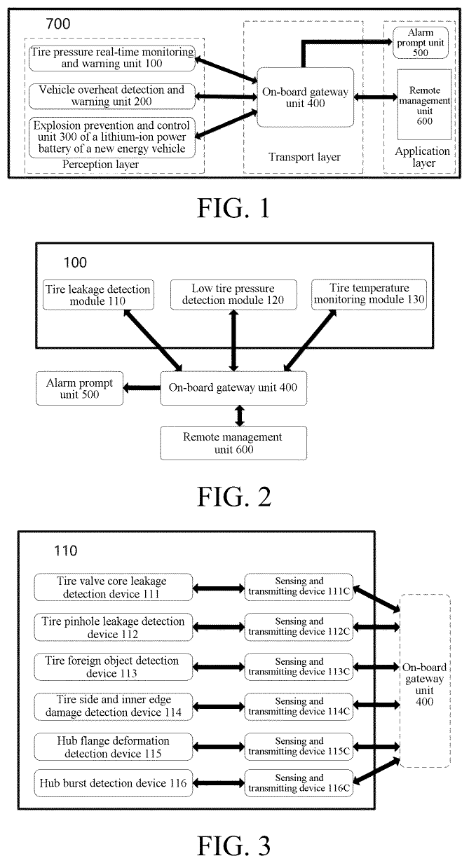

FIG. 2 is a schematic diagram of a composition principle and a use flow chart of a tire pressure real-time monitoring and warning unit 100 according to this example.

Based on FIG. 2, the tire pressure real-time monitoring and warning unit 100 in the vehicle safety monitoring system 700 based on the Internet of Things is mainly composed of a tire leakage detection module 110, a low tire pressure detection module 120, and a tire temperature monitoring module 130, which are in cooperation with each other.

FIG. 6 is a schematic diagram of a composition principle of an on-board gateway unit and a network communication module thereof.

Based on FIG. 6, the on-board gateway unit 400 of the vehicle safety monitoring system 700 based on the Internet of Things includes a network communication module 410, a data storage module 420, and an edge computing module 430, which are in cooperation with each other.

In conjunction with FIG. 1, FIG. 2, and FIG. 6, the tire leakage detection module 110 in the tire pressure real-time monitoring and warning unit 100 is configured to obtain real-time information on whether each tire of the vehicle has air leakage condition, and transmit the obtained information to the data storage module of the on-board gateway unit 400, the edge computing module, or to the remote management unit 600 through the network communication module of the on-board gateway unit.

The low tire pressure detection module 120 in the tire pressure real-time monitoring and warning unit 100 is configured to obtain real-time information on the air pressure condition of each tire of the vehicle, and transmit the obtained information to the data storage module of the on-board gateway unit 400, the edge computing module, or to the remote management unit 600 through the network communication module of the on-board gateway unit.

The tire temperature monitoring module 130 in the tire pressure real-time monitoring and warning unit 100 is configured to obtain real-time information on an internal temperature condition of each tire of the vehicle, and transmit the obtained information to the data storage module of the on-board gateway unit 400, the edge computing module, or to the remote management unit 600 through the network communication module of the on-board gateway unit.

Based on FIG. 1, FIG. 2, and FIG. 6, the tire pressure real-time monitoring and warning unit 100 arranged in this way is convenient to use the tire leakage detection module 110 to collect real-time information on whether each tire of the vehicle has a leak, use the low tire pressure detection module 120 to collect real-time information on the air pressure condition of each tire of the vehicle, collect real-time information on the internal temperature of each tire of the vehicle through the tire temperature monitoring module 130, and send the detection information of a plurality of detection devices of the tire leakage detection module 110 of the tire pressure real-time monitoring and warning unit, the low tire pressure detection module 120, and the tire temperature monitoring module 130 to the on-board gateway unit 400. Intelligent analysis and determination are performed by the edge computing module 430 of the on-board gateway unit 400. When the air leakage, the deformation, or the temperature intelligent analysis result of the corresponding detection object triggers the real-time monitoring and warning of tire leakage, the network communication module 410 of the on-board gateway unit 400 sends a corresponding acousto-optic alarm or voice prompt to the alarm prompt unit 500, and at the same time uploads the alarm prompt information to the remote management unit 600 through the network communication module 410 of the on-board gateway unit 400.

Based on FIG. 1, the vehicle overheat detection and warning unit 200 in this system is arranged in an automobile engine/motor, a differential lock system, a tire and/or exhaust pipe air outlet, is associated with the on-board gateway unit 400, and is associated with the alarm prompt unit 500 and the remote management unit 600 through the on-board gateway unit 400.

The vehicle overheat detection and warning unit 200 can collect engine/motor temperature, differential lock system temperature, tire temperature and/or exhaust pipe temperature information of the current vehicle. The vehicle overheat detection and warning unit stores the collected engine/motor temperature, differential lock system temperature, tire temperature and/or exhaust pipe temperature information in the data storage module of the on-board gateway unit. The vehicle overheat detection and warning unit 200 further analyzes the collected engine/motor temperature, differential lock system temperature, tire temperature and/or exhaust pipe temperature through the sensor or through the edge computing module of the on-board gateway unit, and determines whether the vehicle is overheated and there is a risk of explosion or damage. Accordingly, when it is determined that the detection information analysis result is higher than the set temperature threshold to trigger the vehicle overheat alarm, a warning or an alarm message is sent to the remote management unit 600 through a network communication module of the on-board gateway unit 400, and at the same time, a corresponding local warning acousto-optic, or voice prompt is sent through the alarm prompt unit 500 to prompt the driver to stop for inspection.

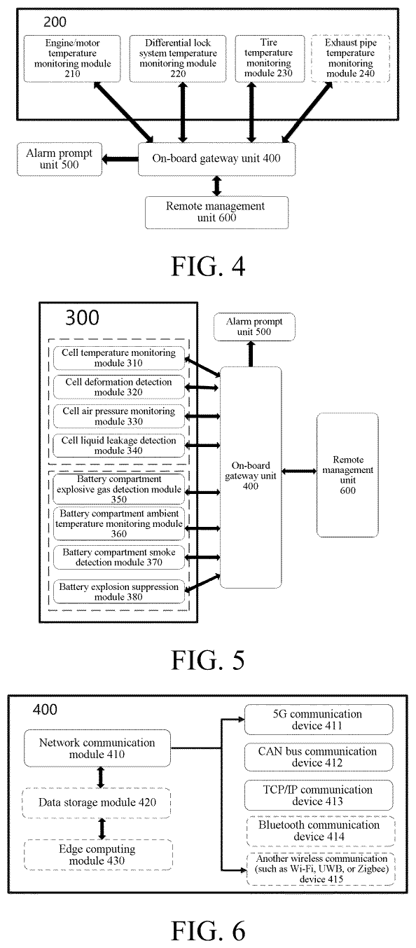

FIG. 4 is a schematic diagram of a composition principle and a use flow chart of a vehicle overheat detection and warning unit 200 in the vehicle safety monitoring system based on the Internet of Things according to this example.

Based on FIG. 4, the vehicle overheat detection and warning unit 200 provided in this example includes an engine/motor temperature monitoring module 210, a differential lock system temperature monitoring module 220, a tire temperature monitoring module 230, and/or an exhaust pipe temperature monitoring module 240. The engine temperature monitoring module 210 is used in the vehicle overheat detection and warning unit 200 of a fuel vehicle, and the motor temperature monitoring module 210 is used in the vehicle overheat detection and warning unit 200 of the new energy vehicle, and does not include the exhaust pipe temperature monitoring module 240.

Based on FIG. 1, FIG. 4, and FIG. 6, the engine/motor temperature monitoring module 210 in the vehicle overheat detection and warning unit 200 is configured to obtain real-time temperature of the vehicle engine/motor (obtain engine temperature for a fuel-powered vehicle; and obtain motor temperature for a new energy vehicle) information, and transmit the obtained information to the data storage module of the on-board gateway unit 400, the edge computing module, or to the remote management unit 600 through the network communication module of the on-board gateway unit 400.

The differential lock system temperature monitoring module in the vehicle overheat detection and warning unit 200 is configured to obtain real-time temperature information of the vehicle differential lock system, and transmit the obtained information to the data storage module of the on-board gateway unit 400, the edge computing module, or to the remote management unit 600 through the network communication module of the on-board gateway unit 400.

The tire temperature monitoring module in the vehicle overheat detection and warning unit 200 is configured to obtain real-time temperature information of the vehicle tire, and transmit the obtained information to the data storage module of the on-board gateway unit 400, the edge computing module, or to the remote management unit 600 through the network communication module of the on-board gateway unit 400.

The exhaust pipe temperature monitoring module in the vehicle overheat detection and warning unit 200 is configured to obtain real-time temperature information of the exhaust pipe of the fuel vehicle, and transmit the obtained information to the data storage module of the on-board gateway unit 400, the edge computing module, or to the remote management unit 600 through the network communication module of the on-board gateway unit 400.

Based on FIG. 1, FIG. 4, and FIG. 6, the vehicle overheat detection and warning unit 200 arranged in this way collects engine/motor temperature information of the current vehicle through the engine/motor temperature monitoring module 210, collects differential lock system temperature information of the current vehicle through the differential lock system temperature monitoring module 220, collects the tire temperature information of the current vehicle through the tire temperature monitoring module 230, and/or collects the exhaust pipe temperature information of the current vehicle through the exhaust pipe temperature monitoring module 240, and stores the information in the data storage module 420 of the on-board gateway unit 400. The collected engine/motor temperature, differential lock system temperature, tire temperature and/or exhaust pipe temperature are analyzed by the sensor or by the edge computing module 430 of the on-board gateway unit 400 to determine whether the vehicle is overheated and there is a risk of explosion or damage. When it is determined that the detection information analysis result is higher than the set temperature threshold to trigger the vehicle overheat alarm, a warning or an alarm message is sent to the remote management unit 600 through a network communication module 410 of the on-board gateway unit 400 at the same time, a corresponding local warning acousto-optic, or voice prompt is sent through the alarm prompt unit 500 to prompt the driver to stop for inspection.

Based on FIG. 1, the explosion prevention and control unit 300 of the lithium-ion power battery of the new energy vehicle in this system is arranged in a cell of the lithium-ion power battery of the new energy vehicle and in a battery compartment, is associated with the on-board gateway unit 400, and is associated with the alarm prompt unit 500 and the remote management unit 600 through the on-board gateway unit 400.

explosion prevention and control unit 300 of the lithium-ion power battery of the new energy vehicle can collect the cell temperature, the cell deformation, the cell air pressure, the cell leakage, the battery compartment explosive gas concentration, the battery compartment ambient temperature, and the battery compartment smoke information of the current vehicle. The explosion prevention and control unit 300 of the lithium-ion power battery of the new energy vehicle stores the cell temperature, the cell deformation, the cell air pressure, the cell leakage, the battery compartment explosive gas concentration, the battery compartment ambient temperature, and the battery compartment smoke information in the data storage module of the on-board gateway unit.

Meanwhile, the explosion prevention and control unit 300 of the lithium-ion power battery of the new energy vehicle analyzes the collected cell temperature, the cell deformation, the cell air pressure, the cell leakage, the battery compartment explosive gas concentration, the battery compartment ambient temperature, and the battery compartment smoke information through the sensor or through the edge computing module of the on-board gateway unit, and determines whether the vehicle power battery has an explosion risk or a combustion risk. Accordingly, when it is determined that the detection information analysis result is higher than the relevant set threshold to trigger a power cell hazard or a battery compartment hazard alarm, the battery explosion suppression device is activated, a warning or an alarm message is sent to the remote management unit through a network communication module of the on-board gateway unit. At the same time, a corresponding local warning acousto-optic, or voice prompt is sent through the alarm prompt unit to prompt the driver to stop for inspection.

FIG. 5 is a schematic diagram of a composition principle and a use flow chart of an explosion prevention and control unit of a lithium-ion power battery of a new energy vehicle in the vehicle safety monitoring system based on the Internet of Things according to this example.

Based on FIG. 5, the explosion prevention and control unit 300 of the lithium-ion power battery of the new energy vehicle provided in this example is composed of a cell temperature monitoring module 310, a cell deformation detection module 320, a cell air pressure monitoring module 330, a cell liquid leakage detection module 340, a battery compartment explosive gas detection module 350, a battery compartment ambient temperature monitoring module 360, a battery compartment smoke detection module 370, and a battery explosion suppression module 380, which are in cooperation with each other.

The cell temperature monitoring module 310 in the explosion prevention and control unit 300 of the lithium-ion power battery of the new energy vehicle is configured to obtain the real-time temperature information of the cell of the vehicle power battery, and transmit the obtained information to the data storage module of the on-board gateway unit 400, the edge computing module, or to the remote management unit 600 through the network communication module of the on-board gateway unit 400.

The cell deformation detection module 320 in the explosion prevention and control unit 300 of the lithium-ion power battery of the new energy vehicle is configured to obtain real-time deformation information of the cell of the vehicle power battery, and transmit the obtained information to the data storage module of the on-board gateway unit 400, the edge computing module, or to the remote management unit 600 through the network communication module of the on-board gateway unit 400.

The cell air pressure monitoring module 330 in the tire pressure real-time monitoring and warning unit 300 is configured to obtain real-time air pressure information of the cell of the vehicle power battery, and transmit the obtained information to the data storage module of the on-board gateway unit 400, the edge computing module, or to the remote management unit 600 through the network communication module of the on-board gateway unit 400.

The cell liquid leakage detection module 340 in the explosion prevention and control unit 300 of the lithium-ion power battery of the new energy vehicle is configured to obtain real-time liquid leakage information of the cell of the vehicle power battery, and transmit the obtained information to the data storage module of the on-board gateway unit 400, the edge computing module, or to the remote management unit 600 through the network communication module of the on-board gateway unit 400.

The battery compartment explosive gas detection module 350 in the explosion prevention and control unit 300 of the lithium-ion power battery of the new energy vehicle is configured to obtain composition and real-time concentration information of an explosive gas in the vehicle power battery compartment, and transmit the obtained information to the data storage module of the on-board gateway unit 400, the edge computing module, or to the remote management unit 600 through the network communication module of the on-board gateway unit 400.

The battery compartment ambient temperature monitoring module 360 in the explosion prevention and control unit 300 of the lithium-ion power battery of the new energy vehicle is configured to obtain ambient temperature information of the vehicle power battery compartment, and transmit the obtained information to the data storage module of the on-board gateway unit 400, the edge computing module, or to the remote management unit 600 through the network communication module of the on-board gateway unit 400.

The battery compartment smoke detection module 370 in the explosion prevention and control unit 300 of the lithium-ion power battery of the new energy vehicle is configured to obtain information on whether there is smoke in the vehicle power battery compartment, and transmit the obtained information to the data storage module of the on-board gateway unit 400, the edge computing module, or to the remote management unit 600 through the network communication module of the on-board gateway unit 400.

The battery explosion suppression module 380 of the battery compartment in the explosion prevention and control unit 300 of the lithium-ion power battery of the new energy vehicle is configured to cut off power supply or perform fire extinguishing and explosion-proof treatment when the lithium-ion power battery explosion warning information appears.

Based on FIG. 1, FIG. 5, and FIG. 6, the explosion prevention and control unit 300 of the lithium-ion power battery of the new energy vehicle arranged in this way collects the cell temperature of the current vehicle through the cell temperature monitoring module 310, collects the cell deformation of the current vehicle through the cell deformation detection module 320, collects the cell pressure of the current vehicle through the cell air pressure monitoring module 330, collects the cell leakage of the current vehicle through the cell liquid leakage detection module 340, collects the explosive gas concentration of the battery compartment of the current vehicle through the battery compartment explosive gas detection module 350, collects the ambient temperature of the battery compartment of the current vehicle through the battery compartment ambient temperature monitoring module 360, and collects the battery compartment smoke information of the current vehicle through the battery compartment smoke detection module 370. The collected cell temperature, cell deformation, cell air pressure, cell leakage, battery compartment explosive gas concentration, battery compartment ambient temperature, and battery compartment smoke information are stored in the data storage module 420 of the on-board gateway unit 400 through the network communication module 410 of the on-board gateway unit 400. The collected cell temperature, the cell deformation, the cell air pressure, the cell leakage, the battery compartment explosive gas concentration, the battery compartment ambient temperature, and the battery compartment smoke information are analyzed through the sensor or through the edge computing module 430 of the on-board gateway unit 400, and whether the vehicle power battery has an explosion risk or a combustion risk is determined. When it is determined that the detection information analysis result is higher than the relevant set threshold to trigger a power cell hazard or a battery compartment hazard alarm, the relevant battery explosion suppression device of the battery explosion suppression module 380 is activated, a warning or an alarm message is sent to the remote management unit 600 through a network communication module 410 of the on-board gateway unit 400. At the same time, a corresponding local warning acousto-optic, or voice prompt is sent through the alarm prompt unit 500 to prompt the driver to stop for inspection.

Based on FIG. 1, the on-board gateway unit 400 in this system is arranged in a vehicle cab, and is respectively associated with the tire pressure real-time monitoring and warning unit 100, the vehicle overheat detection and warning unit 200 and/or the explosion prevention and control unit 300 of a lithium-ion power battery of a new energy vehicle, the alarm prompt unit 500, and the remote management unit 600.

The on-board gateway unit 400 has at least a network communication function, a data storage function, and an edge computing function, and can establish a communication channel with the remote management unit 600, to analyze the sensing detection data information generated by the tire pressure real-time monitoring and warning unit, the vehicle overheat detection and warning unit, and/or the explosion prevention and control unit of a lithium-ion power battery of a new energy vehicle. When the analysis result triggers an alarm, alarm information is respectively sent to the remote management unit 600 and the alarm prompt unit 500, and management commands such as the threshold setting adjustment of the remote management unit 600 are sent to the tire pressure real-time monitoring and warning unit, the vehicle overheat detection and warning unit, and/or the explosion prevention and control unit of a lithium-ion power battery of a new energy vehicle.

FIG. 6 is a schematic diagram of a configuration principle and a network communication module of the on-board gateway unit in the vehicle safety monitoring system based on the Internet of Things according to this example.

Based on FIG. 6, the on-board gateway unit 400 provided in this example is composed of a network communication module 410, a data storage module 420, and an edge computing module 430 combined with each other.

The network communication module 410 in the on-board gateway unit 400 is used for data exchange between the tire pressure real-time monitoring and warning unit, the vehicle overheat detection and warning unit, the explosion prevention and control unit of a lithium-ion power battery of a new energy vehicle, the alarm prompt unit, and the remote management unit; can transmit the tire pressure real-time monitoring information uploaded by the tire pressure real-time monitoring and warning unit, the overheating detection information of each module of the vehicle uploaded by the vehicle overheat detection and warning unit, and forward the lithium-ion power cell and the battery compartment detection information and the analysis result of the detection information uploaded by the explosion prevention and control unit of a lithium-ion power battery of a new energy vehicle to the remote management unit; forwards alarm command and voice prompt command information to the alarm prompt unit according to the received remote management unit command, and forward command information such as alarm threshold setting adjustment and circuit control to the relevant detection devices of the tire pressure real-time monitoring and warning unit, the vehicle overheat detection and warning unit, and the explosion prevention and control unit of a lithium-ion power battery of a new energy vehicle.

The data storage module 420 in the on-board gateway unit 400 is configured to store the detection information uploaded by the tire pressure real-time monitoring and warning unit, the vehicle overheat detection and warning unit, the explosion prevention and control unit of a lithium-ion power battery of a new energy vehicle.

The edge computing module 430 in the on-board gateway unit 400 is configured to intelligently analyze and determine the detection information uploaded by the tire pressure real-time monitoring and warning unit, the vehicle overheat detection and warning unit, and the explosion prevention and control unit of the lithium-ion power battery of the new energy vehicle.

Based on FIG. 1 and FIG. 6, the on-board gateway unit 400 arranged in this way performs data exchange between the tire pressure real-time monitoring and warning unit 100, the vehicle overheat detection and warning unit 200, the explosion prevention and control unit 300 of the lithium-ion power battery of the new energy vehicle, the alarm prompt unit 500, and the remote management unit 600 through the network communication module 410. The tire pressure real-time monitoring information uploaded by the tire pressure real-time monitoring and warning unit 100, the overheating detection information of each module of the vehicle uploaded by the vehicle overheat detection and warning unit 200, and the lithium-ion power cell and battery compartment detection information and the analysis result of the detection information uploaded by the explosion prevention and control unit 300 of the lithium-ion power battery of the new energy vehicle are forwarded to the remote management unit 600. Alternatively, the on-board gateway unit forwards the alarm command and voice prompt command information to the alarm prompt unit 500 according to the received command from the remote management unit 600, and forwards command information, such as the alarm threshold setting adjustment and the circuit control, to the relevant detection devices of the tire pressure real-time monitoring and warning unit 100, the vehicle overheat detection and warning unit 200, and the explosion prevention and control unit 300 of the lithium-ion power battery of the new energy vehicle.

The on-board gateway unit 400 can store the detection information uploaded by the tire pressure real-time monitoring and warning unit 100, the vehicle overheat detection and warning unit 200, and the explosion prevention and control unit 300 of the lithium-ion power battery of the new energy vehicle through the data storage module 420 of the on-board gateway unit 400.

The on-board gateway unit 400 can intelligently analyze and determine the detection information uploaded by the tire pressure real-time monitoring and warning unit 100, the vehicle overheat detection and warning unit 200, and the explosion prevention and control unit 300 of the lithium-ion power battery of the new energy vehicle through the edge computing module 430 of the on-board gateway unit 400. When the analysis result triggers an alarm, alarm information is respectively sent to the remote management unit 600 and the alarm prompt unit 500, and management commands such as the threshold setting adjustment of the remote management unit 600 are sent to the tire pressure real-time monitoring and warning unit 100, the vehicle overheat detection and warning unit 200, and/or the explosion prevention and control unit 300 of the lithium-ion power battery of the new energy vehicle.

Based on FIG. 1, the alarm prompt unit 500 in the system may be arranged in the vehicle cab, the monitoring client software of a vehicle exterior and the remote management unit 600, and is associated with the on-board gateway unit 300 of the vehicle.

The alarm prompt unit 500 is arranged in a cab of automobile transportation and outside the vehicle through a local acousto-optic alarm or a voice prompt device, and is connected with the on-board gateway unit. The local alarm prompt unit formed in this way sends a voice prompt or an acousto-optic alarm according to the detection and analysis result sent by the on-board gateway unit.

The alarm prompt unit 500 also displays the government industry management client software, the enterprise operation management client software, and the driver and passenger service client software set in the remote management unit through remote monitoring of the client alarm, and is connected to the on-board gateway unit. The detection client of a remote alarm prompt unit formed in this way sends a voice or text prompt according to the detection analysis result sent by the on-board gateway unit.

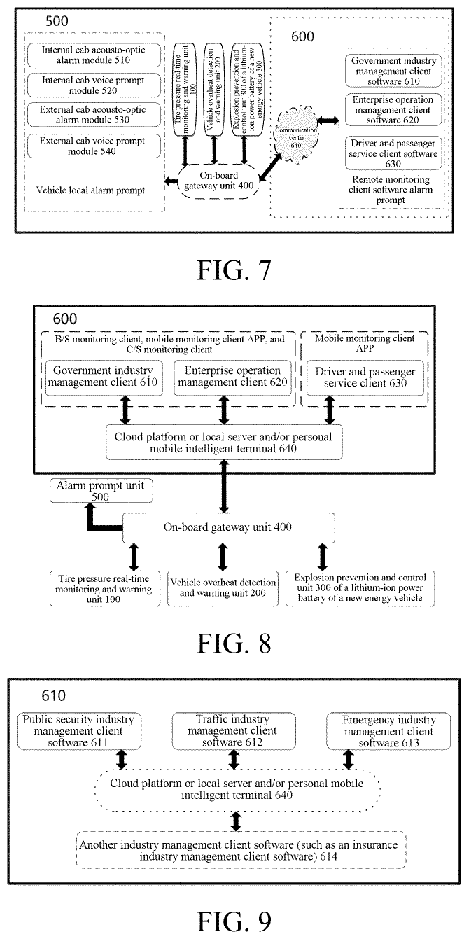

FIG. 7 is a schematic diagram of a composition principle and a use flow chart of an alarm prompt unit in the vehicle safety monitoring system based on the Internet of Things according to this example.

Based on FIG. 7, the alarm prompt unit 500 provided in this example is composed of vehicle local alarm prompt subunits, such as an internal cab acousto-optic alarm module 510, an internal cab voice prompt module 520, an external cab acousto-optic alarm module 530, and an external cab voice prompt module 540, and remote monitoring client software alarm prompt subunits, such as a government industry management client 610, an enterprise operation management client 620, and a driver and passenger service client 630, which are in cooperation with each other.

The internal cab acousto-optic alarm module 510 in the alarm prompt unit 500 is configured to send an acousto-optic alarm when receiving the tire pressure real-time monitoring and warning information, the vehicle overheat detection and warning formation, and the explosion warning information of a lithium-ion power battery of a new energy vehicle. The light emitted by the acousto-optic alarm of the acousto-optic alarm module is generally red by default.

The internal cab voice prompt module 520 in the alarm prompt unit 500 is configured to send a voice prompt when receiving the tire pressure real-time monitoring and warning information, the vehicle overheat detection and warning formation, and the explosion warning information of a lithium-ion power battery of a new energy vehicle, reminding the driver to stop nearby or stop immediately for inspection. The internal cab voice prompt module can be arranged independently with the internal cab acousto-optic alarm module or combined into a voice acousto-optic alarm.

The external cab acousto-optic alarm module 530 in the alarm prompt unit 500 is configured to send an acousto-optic alarm when receiving the high-risk level tire pressure real-time monitoring and warning information, the vehicle overheat detection and warning formation, and the explosion warning information of a lithium-ion power battery of a new energy vehicle. The light emitted by the acousto-optic alarm of the acousto-optic alarm module is generally red by default. The alarm sound is loud enough to alert passers-by in a noisy environment on a road.

The external cab voice prompt module 540 in the alarm prompt unit 500 is configured to send a voice prompt when receiving the high-risk level tire pressure real-time monitoring and warning information, the vehicle overheat detection and warning formation, and the explosion warning information of a lithium-ion power battery of a new energy vehicle, reminding other personnel on the road to avoid as soon as possible. The voice broadcast clarity of a voice warning content is sufficient to be clearly understood by a listener.

The government industry management client 610 in the alarm prompt unit 500 is configured to receive the alarm information forwarded by the on-board gateway unit through the communication center when the high-risk level tire pressure real-time monitoring and warning information, the vehicle overheat detection and warning formation, and the explosion warning information of a lithium-ion power battery of a new energy vehicle appear. When the government industry management client 610 receives the high-risk level tire pressure real-time monitoring and warning information, the vehicle overheat detection and warning formation, and the explosion warning information of a lithium-ion power battery of a new energy vehicle, an emergency management process is started by default according to the emergency plan.

The enterprise operation management client 620 in the alarm prompt unit 500 is configured to the alarm information forwarded by the on-board gateway unit through the communication center when the tire pressure real-time monitoring and warning information, the vehicle overheat detection and warning formation, and the explosion warning information of a lithium-ion power battery of a new energy vehicle appear. When the enterprise operation management client 620 receives the high-risk level tire pressure real-time monitoring and warning information, the vehicle overheat detection and warning formation, and the explosion warning information of a lithium-ion power battery of a new energy vehicle, the enterprise operation management client starts the emergency management process according to the emergency plan by default and sends emergency alarm information to the government industry management client synchronously.

The driver and passenger service client 630 in the alarm prompt unit 500 is configured to receive the alarm information forwarded by the on-board gateway unit through the communication center when the tire pressure real-time monitoring and warning information, the vehicle overheat detection and warning formation, and the explosion warning information of a lithium-ion power battery of a new energy vehicle appear. The driver and passenger service client 630 sends the voice prompt while sending an alarm message.

Based on FIG. 1 and FIG. 7, the alarm prompt unit 500 arranged in this way sends an acousto-optic alarm when the tire pressure real-time monitoring and warning information, the vehicle overheat detection and warning formation, and the explosion warning information of a lithium-ion power battery of a new energy vehicle are received by the internal cab acousto-optic alarm module 510;
may send a voice prompt when the tire pressure real-time monitoring and warning information, the vehicle overheat detection and warning formation, and the explosion warning information of a lithium-ion power battery of a new energy vehicle are received by the internal cab voice prompt module 520, reminding the driver to stop nearby or stop immediately for inspection;
may send an acousto-optic alarm when the high-risk level tire pressure real-time monitoring and warning information, the vehicle overheat detection and warning formation, and the explosion warning information of a lithium-ion power battery of a new energy vehicle are received by the external cab acousto-optic alarm module 530;
may send a voice prompt when the high-risk level tire pressure real-time monitoring and warning information, the vehicle overheat detection and warning formation, and the explosion warning information of a lithium-ion power battery of a new energy vehicle are received by the external cab voice prompt module 540, reminding other personnel on the road to avoid as soon as possible;
may start an emergency management process according to the emergency plan when the government industry management client 610 receives the high-risk level tire pressure real-time monitoring and warning information, the vehicle overheat detection and warning formation, and the explosion warning information of a lithium-ion power battery of a new energy vehicle forwarded by the on-board gateway unit unit through the communication center;
may receive the high-risk level tire pressure real-time monitoring and warning information, the vehicle overheat detection and warning formation, and the explosion warning information of a lithium-ion power battery of a new energy vehicle forwarded by the on-board gateway unit through the communication center by the enterprise operation management client 620, and start the emergency management process according to the emergency plan and send emergency alarm information to the government industry management client synchronously when receiving high-risk level warning and alarm information; and
may receive the tire pressure real-time monitoring and warning information, the vehicle overheat detection and warning formation, and the explosion warning information of a lithium-ion power battery of a new energy vehicle forwarded by the on-board gateway unit through the communication center by the driver and passenger service client 630 and send the voice prompt.

Based on FIG. 1, the remote management unit 600 in the system is arranged on a cloud platform of the government industry authority related to automobile transportation and/or a local storage server and/or a personal handheld intelligent terminal of a relevant management personnel, a cloud platform and/or a local storage server and/or a personal handheld intelligent terminal of a relevant management personnel of a transportation enterprise and a transportation related party to which the vehicle belongs, and a personal handheld intelligent terminal of a driver and passenger. The remote management unit 600 is also directly associated with the on-board gateway unit 400 of the vehicle, and is indirectly associated with the tire pressure real-time monitoring and warning unit 100, the vehicle overheat detection and warning unit 200, the explosion prevention and control unit 300 of the lithium-ion power battery of the new energy vehicle, and the alarm prompt unit 500 through the on-board gateway unit 400.

The remote management unit 600 can send commands to set and adjust the alarm threshold of the relevant sensors of the tire pressure real-time monitoring and warning unit, the vehicle overheat detection and warning unit, and/or the explosion prevention and control unit of a lithium-ion power battery of a new energy vehicle, receive the tire pressure alarm information, the vehicle overheat alarm information, and/or the explosion risk alarm information of a lithium-ion power battery of a new energy vehicle sent by the on-board gateway unit, and send emergency response and emergency rescue management information according to the requirements of the emergency plan when receiving a high-risk alarm.

FIG. 8 is a schematic diagram of a composition principle and a use flow chart in a remote management unit of the vehicle safety monitoring system based on the Internet of Things according to this example.

Based on FIG. 8, the remote management unit 600 provided in this example includes a government industry management client 610, an enterprise operation management client 620, a driver and passenger service client 630, and a communication center (a cloud platform or a local server and/or a personal mobile intelligent terminal) 640, which are in cooperation with each other.

It should be noted here that in the specific application of this solution, the remote management unit of the vehicle safety monitoring system for an operational vehicle includes the above three types of detection client, and the remote management unit of the vehicle safety monitoring system for a private vehicle has at least a public security industry management client in the driver and passenger service client and the government industry management client software.

The government industry management client 610 in the remote management unit 600 is configured to receive and display high-risk level tire pressure real-time monitoring and warning information, vehicle overheat detection and warning information, and explosion warning information of a lithium-ion power battery of a new energy vehicle forwarded by the tire pressure real-time monitoring and warning unit, the tire pressure real-time monitoring and warning unit, and the explosion prevention and control unit of a lithium-ion power battery of a new energy vehicle through the on-board gateway unit and the communication center, send relevant management commands according to the received warning and alarm information, start the emergency management process, and issue relevant emergency response commands.

The enterprise operation management client 620 in the remote management unit 600 is configured to receive and display tire pressure real-time monitoring and warning information, vehicle overheat detection and warning information, and explosion warning information of a lithium-ion power battery of a new energy vehicle forwarded by the tire pressure real-time monitoring and warning unit, the tire pressure real-time monitoring and warning unit, and the explosion prevention and control unit of a lithium-ion power battery of a new energy vehicle through the on-board gateway unit and the communication center, send relevant management commands according to the received warning and alarm information. When the enterprise operation management client 620 receives the high-risk level tire pressure real-time monitoring and warning information, the vehicle overheat detection and warning formation, and the explosion warning information of a lithium-ion power battery of a new energy vehicle, the emergency management process is started, an emergency alarm is sent to the government industry management client, and relevant emergency response commands are issued.

The driver and passenger service client 630 in the remote management unit 600 is configured to receive and display tire pressure real-time monitoring and warning information, vehicle overheat detection and warning information, and explosion warning information of a lithium-ion power battery of a new energy vehicle forwarded by the tire pressure real-time monitoring and warning unit, the tire pressure real-time monitoring and warning unit, and the explosion prevention and control unit of a lithium-ion power battery of a new energy vehicle through the on-board gateway unit and the communication center, and send an acousto-optic alarm, a voice prompt, and an emergency rescue guide corresponding to the alarm and warning information to prompt the driver to stop nearby or stop immediately for inspection, and provide a corresponding emergency response guide plan according to the received alarm and warning information.

The communication center 640 in the remote management unit 600 is configured to communicate with the on-board gateway unit, receive and store the tire pressure real-time monitoring and warning information, the vehicle overheat detection and warning information, and the explosion warning information of the lithium-ion power battery of the new energy vehicle forwarded by the tire pressure real-time monitoring and warning unit, the tire pressure real-time monitoring and warning unit, and the explosion prevention and control unit of the lithium-ion power battery of the new energy vehicle through the on-board gateway unit, and forward to the government industry management client 610, the enterprise operation management client 620, and the driver and passenger service client 630 respectively. The communication center 640 also serves as a computer system environment for the government industry management client 610, the enterprise operation management client 620, and the driver and passenger service client 630, supports a related client software application, and forwards the management commands or response commands of the government industry management client 610, the enterprise operation management client 620, and the driver and passenger service client 630 to the on-board gateway unit.

Based on FIG. 1 and FIG. 8, the government industry management client 610 arranged in this way can receive and display real-time monitoring and warning information of high-risk level tire pressure real-time monitoring and warning information, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of the lithium-ion power battery of the new energy vehicle through the on-board gateway unit 400 and the communication center 640 by the remote management unit 600, send relevant management commands according to the received warning and alarm information, start the emergency management process, and issue relevant emergency response commands.

The remote management unit 600 can receive and display tire pressure real-time monitoring and warning information, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of the lithium-ion power battery of the new energy vehicle through the on-board gateway unit 400 and the communication center 640 by the enterprise operation management client 620, and send relevant management commands according to the received warning and alarm information.

The remote management unit 600 can receive and display tire pressure real-time monitoring and warning information, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of the lithium-ion power battery of the new energy vehicle through the on-board gateway unit 400 and the communication center 640 by the driver and passenger service client 630, and send an acousto-optic alarm, a voice prompt, and an emergency rescue guide corresponding to the alarm and warning information to prompt the driver to stop nearby or stop immediately for inspection, and provide a corresponding emergency response guide plan according to the received alarm and warning information.

The remote management unit 600 can communicate with the on-board gateway unit 400 through the communication center 640, receive and store the tire pressure real-time monitoring and warning information, the vehicle overheat detection and warning information, and the explosion warning information of a lithium-ion power battery of a new energy vehicle forwarded by the tire pressure real-time monitoring and warning unit 100, the tire pressure real-time monitoring and warning unit 200, and the explosion prevention and control unit 300 of the lithium-ion power battery of the new energy vehicle through the on-board gateway unit 400, and forward to the government industry management client 610, the enterprise operation management client 620, and the driver and passenger service client 630 respectively. The communication center 640 also serves as a computer system environment for the government industry management client 610, the enterprise operation management client 620, and the driver and passenger service client 630, supports a related software application, and forwards the management commands or response commands of the government industry management client 610, the enterprise operation management client 620, and the driver and passenger service client 630 to the on-board gateway unit 400.

In the vehicle safety monitoring system 700 based on the Internet of Things formed accordingly, the tire pressure real-time monitoring and warning unit 100, the vehicle overheat detection and warning unit 200, and/or the explosion prevention and control unit 300 of the lithium-ion power battery of the new energy vehicle form a sensing layer of the Internet of things of the vehicle safety monitoring system 700. Meanwhile, the in-on-board gateway unit 400 forms a transport layer of the Internet of things of the vehicle safety monitoring system 700, and the alarm prompt unit 500 and remote management unit 600 project form an application layer of the Internet of things of the vehicle safety monitoring system 700.

When the vehicle safety monitoring system 700 is deployed and applied, the tire leakage detection module of the tire pressure real-time monitoring and warning unit is configured to monitor the tire leakage in real time, the low tire pressure detection module is configured to monitor the tire low pressure condition in real time, and the tire temperature monitoring module is configured to monitor an internal temperature of the tire in real time. When there is a tire leak, when the air pressure is lower than the set threshold, or when the temperature is higher than the set threshold and there may be a risk of tire blowout due to excessive air pressure, the warning message is sent. When the warning is triggered, while sending the warning information to the remote management unit, the local warning acousto-optic, or voice prompt is sent through the alarm prompt unit;
the engine/motor temperature monitoring module, the differential lock system temperature monitoring module, the tire temperature monitoring module, and/or the exhaust pipe temperature monitoring module in the vehicle overheat detection and warning unit is configured to perform real-time temperature monitoring simultaneously while the vehicle runs, such as an engine/motor, a differential lock system, a tire and/or exhaust pipe. When the temperature of the detection object is higher than the set threshold, a warning message is sent. When the warning is triggered, while sending the warning information to the remote management unit, the local warning acousto-optic, or voice prompt is sent through the alarm prompt unit; and
for the new energy vehicle, the explosion prevention and control unit of a lithium-ion power battery of a new energy vehicle may be arranged, and the cell temperature monitoring module, the cell deformation detection module, the cell air pressure monitoring module, the cell liquid leakage detection module, the battery compartment explosive gas detection module, the battery compartment ambient temperature monitoring module, the battery compartment smoke detection module, and the battery explosion suppression module are configured to monitor the cell temperature, the cell deformation, the cell air pressure, the liquid leakage condition, the battery compartment explosive gas concentration, the battery compartment ambient temperature, and the battery compartment smoke condition in real time, warning information is sent when the monitoring result is higher than a set threshold or the leakage occurs, when a medium or low risk warning is triggered, a local warning sound-light or voice prompt is sent through the alarm prompt unit while the warning information is sent to the remote management unit, and when a high risk warning is triggered, an explosion suppression device is automatically started, and the local warning sound-light or voice prompt is sent through the alarm prompt unit while the warning information is sent to the remote management unit.

The vehicle safety monitoring system 700 uses the on-board gateway unit to communicate and exchange data with a plurality of sensors installed in the tire pressure real-time monitoring and warning unit, the vehicle overheat detection and warning unit and the explosion prevention and control unit of the lithium-ion power battery of the new energy vehicle through the network communication module, and realizes information interaction with the alarm prompt unit and the remote management unit. The data storage module is configured to aggregate and store detection data of the plurality of sensors, and the edge computing module is configured to intelligently analyze the detection data of the plurality of sensors. When the intelligent analysis result of the plurality of sensor detection data triggers a warning or an alarm, the on-board gateway unit sends the warning or alarm information to the alarm prompt unit and the remote management unit respectively through the network communication module. The alarm prompt unit sends an internal or external acousto-optic alarm or voice prompt through the internal cab acousto-optic alarm module and/or the voice prompt module, the external cab acousto-optic alarm module and/or the voice prompt module, and/or the remote alarm prompt module. The remote management unit can display the alarm prompt result or set the relevant sensor warning alarm threshold through the government industry management client, the enterprise operation management client, and the driver and passenger service client, respectively.

The vehicle safety monitoring system 700 can automatically monitor safety monitoring information of a vehicle. When the vehicle is in danger, the driver is provided acousto-optic warning alarm or voice prompt to remind the driver to get off a bus for inspection and processing in time. Through a battery explosion suppression module, a power battery explosion warning and alarm condition is automatically handled to prevent a traffic safety accident caused by a vehicle tire blowout, a vehicle body overheat, a power battery explosion, a vehicle spontaneous combustion, and a vehicle explosion incident.

The vehicle safety monitoring system 700 not only comprehensively detects and improves the safety of the operation of a plurality of fuel vehicles and new energy vehicles through the vehicle safety elements, but also uploads the vehicle safety monitoring, warning, and alarm information to a vehicle-owned enterprise and competent industry department in real time, and gains valuable golden handling time for an early deployment of emergency rescue and handling force and a rapid start of emergency rescue, which is of great significance to improve the accident emergency response speed and rescue efficiency of the vehicle-owned enterprise and the competent industry department, prevent the consequences of traffic accident or the expansion of the consequences of vehicle spontaneous combustion and vehicle explosion accident, and ensure the safety of people's lives and property.

On this basis, this example further clearly shows a specific device that may be involved in a constituent module of each unit of the vehicle safety monitoring system based on the Internet of Things.

FIG. 3 is a schematic diagram of a configuration of a tire leakage detection module 110 in the tire pressure real-time monitoring and warning unit 100 according to the example.

Based on FIG. 3, the tire leakage detection module 110 provided in the example is specifically composed of a tire valve core leakage detection device 111, a tire pinhole leakage detection device 112, a tire foreign object detection device 113, a tire side and inner edge damage detection device 114, a hub flange deformation detection device 115, a hub fracture detection device 116, and sensing and transmitting devices 111C to 1116C corresponding to the hub fracture detection device, and the like, which are in cooperation with each other.

The tire valve core leakage detection device 111 in the tire leakage detection module 110 is configured to collect airflow information near a tire valve core;
the tire pinhole leakage detection device 112 in the tire leakage detection module 110 is configured to collect whether there is pinhole with slow air leakage on a tire surface;
the tire foreign object detection device 113 in the tire leakage detection module 110 is configured to monitor whether the tire is punctured into an iron nail, a screw, an iron wire, a glass fragment, a sharp stone, a tile, and another foreign object that may cause tire leakage;
the tire side and inner edge damage detection device 114 in the tire leakage detection module 110 is configured to monitor whether the tire side and inner edge are damaged due to friction and other reasons;
the hub flange deformation detection device 115 in the tire leakage detection module 110 is configured to monitor the deformation condition of the hub flange; and
the hub fracture detection device 116 in the tire leakage detection module 110 is configured to monitor whether the vehicle hub has a fracture condition.

Based on FIG. 2, FIG. 3, and FIG. 6, the tire leakage detection module 110 arranged in this way collects airflow information near the tire valve core through the tire valve core leakage detection device 111, detects whether there is slow air leakage caused by a pinhole on a tire surface through the tire pinhole leakage detection device 112, detects whether the tire is punctured into an iron nail, a screw, an iron wire, a glass fragment, a sharp stone, a tile and another foreign object that may cause tire leakage through the tire foreign object detection device 113; detects whether a side and an inner edge of the tire are damaged through the tire side and inner edge damage detection device 114, detects a deformation condition of a hub flange through the hub flange deformation detection device 115, detects whether a vehicle hub bursts through the hub fracture detection device 116, and performs intelligent analysis and determination by uploading the detection information to the edge computing module 430 of the on-board gateway unit 400 through the corresponding sensing and transmitting devices 111C to 1116C.

When the air leakage, the deformation, or the temperature intelligent analysis result of the corresponding detection object triggers real-time monitoring and warning of the tire leakage, the network communication module 410 of the on-board gateway unit 400 sends a corresponding acousto-optic alarm or a voice prompt to the alarm prompt unit 500, and at the same time uploads the alarm prompt information to the remote management unit 600 through the network communication module 410 of the on-board gateway unit 400.

In a preferred solution, the low tire pressure detection module 120 of the tire pressure real-time monitoring and warning unit 100 may include a direct tire pressure monitoring device and an indirect tire pressure monitoring device and sensing and transmitting devices corresponding to the direct tire pressure monitoring device and the indirect tire pressure monitoring device.

The direct tire pressure monitoring device is configured to collect real-time pressure value information in the tire, and intuitively determine whether the tire is in a low-pressure state; and
the indirect tire pressure monitoring device is configured to collect a real-time speed difference of different tires of the vehicle, and determine consistency of rolling radii of wheels through the speed difference, so as to determine whether a tire is in the low-pressure state.

In a preferred solution, the tire temperature monitoring module 130 of the tire pressure real-time monitoring and warning unit 100 includes a temperature sensing and monitoring device in each tire and a corresponding sensing and transmitting device.

The temperature sensing and monitoring device in the tire here is configured to obtain real-time information on the internal temperature of each tire of the vehicle, and then cooperate with the temperature and the air pressure to determine whether there is a risk of tire blowout. Generally, the temperature sensing and monitoring device can be deployed in conjunction with the tire pressure detection device of the tire, such as use of an integrated pressure temperature sensor.

Accordingly, the tire pressure real-time monitoring and warning unit 100 constructed is preferably directly associated with the on-board gateway unit 400 during specific deployment, and is indirectly associated with the vehicle alarm prompt unit 500 and the remote management unit 600 through the on-board gateway unit 400. The tire leakage detection module, the low tire pressure detection module, and the plurality of detection devices of the tire temperature monitoring module of the tire pressure real-time monitoring and warning unit 100 send the detection information to the network communication module of the on-board gateway unit through the corresponding sensing and transmitting device, aggregate the detection data to the data storage module of the on-board gateway unit, and perform an intelligent analysis through the edge computing module of the on-board gateway unit. When the air leakage, the deformation, or the temperature analysis result of the corresponding detection object triggers real-time monitoring and warning of the tire leakage, the low tire pressure, or the tire burst, the network communication module of the on-board gateway unit sends a corresponding acousto-optic alarm or a voice prompt to the alarm prompt unit, and at the same time uploads the alarm prompt information to the remote management unit through the network communication module of the on-board gateway unit.

In this example, the vehicle overheat detection and warning unit 200 is preferably directly associated with the on-board gateway unit 400 during specific deployment, and is indirectly associated with the vehicle alarm prompt unit 500 and the remote management unit 600 through the on-board gateway unit 400. The plurality of temperature detection devices of the engine/motor temperature monitoring module 210, the differential lock system temperature monitoring module 220, the tire temperature monitoring module 230, and/or the exhaust pipe temperature monitoring module 240 of the vehicle overheat detection and warning unit 200 deployed in such way converge the detection data to the data storage module of the on-board gateway unit through the network communication module of the on-board gateway unit, and perform an intelligent analysis through the edge computing module of the on-board gateway unit. In this way, when the temperature analysis result of the corresponding detection object triggers the vehicle overheat detection and warning, the network communication module of the on-board gateway unit sends a corresponding acousto-optic alarm or a voice prompt to the alarm prompt unit, and at the same time uploads the alarm prompt information to the remote management unit through the network communication module of the on-board gateway unit.

Based on composition characteristics and existing safety problems of the lithium-ion power battery of the new energy vehicle, a corresponding specific configuration example solution is provided for a cell temperature monitoring module 310, a cell deformation detection module 320, a cell air pressure monitoring module 330, a cell liquid leakage detection module 340, a battery compartment explosive gas detection module 350, a battery compartment ambient temperature monitoring module 360, a battery compartment smoke detection module 370, and a battery explosion suppression module 380 in the explosion prevention and control unit 300 of the lithium-ion power battery of the new energy vehicle provided in the example.

As an example, the cell temperature monitoring module 310 in the explosion prevention and control unit 300 of the lithium-ion power battery of the new energy vehicle includes, but is not limited to an internal cell temperature sensing and monitoring device and/or an internal cell resistance tomography device and a corresponding sensing and transmitting device during specific construction.

The internal cell temperature sensing and monitoring device is configured to obtain real-time information on an internal temperature of the lithium-ion power cell of the new energy vehicle, and determine whether the cell has an explosion risk through the temperature.

The internal cell resistance tomography device is configured to obtain internal resistivity distribution information of the lithium-ion power cell of the new energy vehicle, and determine whether there is a temperature abnormality and an explosion risk in the cell through an internal temperature field and an electric field distribution law of the cell.

The cell deformation detection module 320 in the explosion prevention and control unit 300 of the lithium-ion power battery of the new energy vehicle includes, but is not limited to an internal deformation sensing and detection device and/or a cell surface variable resistance detection device and a corresponding sensing and transmitting device during specific construction.

The internal deformation sensing and detection device is configured to obtain real-time information on the deformation condition of the lithium-ion power cell for the new energy vehicle, and determine whether the cell has a bulging or explosion risk through deformation; and
the cell surface variable resistance detection device is configured to obtain variable resistance information on the surface of the lithium-ion power cell of the new energy vehicle, and determine whether the deformation occurs in the cell and whether there is an explosion risk by the law that the variable resistance increases with an increase of the battery deformation.

The cell air pressure monitoring module 330 in the explosion prevention and control unit 300 of the lithium-ion power battery of the new energy vehicle includes, but is not limited to an internal air pressure monitoring device and a corresponding sensing and transmitting device during specific construction. The internal air pressure monitoring device is configured to obtain real-time information on the air pressure inside the lithium-ion power cell of the new energy vehicle, and determine whether the cell has an explosion risk through the air pressure.

The cell liquid leakage detection module 340 in the explosion prevention and control unit 300 of the lithium-ion power battery of the new energy vehicle includes, but is not limited to a battery bus insulation impedance detection device and/or a battery positive and negative bus current detection device and/or a VOC detection device and a corresponding sensing and transmitting device during specific construction.

The battery bus insulation impedance detection device is configured to obtain real-time information of insulation impedance of the single bus of the lithium-ion power battery of the new energy vehicle, and determine whether the cell has the risk of liquid leakage through fluctuation of the insulation impedance;
the battery positive and negative bus current detection device is configured to obtain current balance on the positive and negative bus of the lithium-ion power cell of the new energy vehicle, and determine whether the cell has liquid leakage through the current short circuit condition; and
the VOC detection device is configured to obtain an organic volatile component of the leakage of the lithium-ion power battery monomer of the new energy vehicle, and determine whether there is leakage of a battery monomer through a specific gas component and a corresponding concentration.

The battery compartment explosive gas detection module 350 in the explosion prevention and control unit 300 of the lithium-ion power battery of the new energy vehicle includes, but is not limited to a CO explosive gas detection, sensing, and detection device, an H₂ explosive gas detection, sensing, and detection device, a CH₄ explosive gas detection, sensing, and detection device, a VOC detection device, and a corresponding sensing and transmitting device during specific construction.

The CO explosive gas detection, sensing, and detection device is configured to obtain real-time information on whether there is CO and a gas concentration in the lithium-ion power battery compartment of the new energy vehicle, and determine whether the CO in the battery compartment reaches an upper and lower explosion limit through the detection result;
the H₂ explosive gas detection, sensing, and detection device is configured to obtain real-time information on whether there is H₂ and a gas concentration in the lithium-ion power battery compartment of the new energy vehicle, and determine whether the H₂ in the battery compartment reaches an upper and lower explosion limit through the detection result;
the CH₄ explosive gas detection, sensing, and detection device is configured to obtain real-time information on whether there is CH₄ and a gas concentration in the lithium-ion power battery compartment of the new energy vehicle, and determine whether the CH₄ in the battery compartment reaches an upper and lower explosion limit through the detection result; and
the VOC detection device is configured to obtain real-time information on whether there is CO, and the like and the corresponding gas concentration in the lithium-ion power battery compartment of the new energy vehicle, and determine whether the CO and other gases in the battery compartment reach the upper and lower explosion limit through the detection result.

The battery compartment ambient temperature monitoring module 360 in the explosion prevention and control unit 300 of the lithium-ion power battery of the new energy vehicle includes, but is not limited to a temperature sensing and monitoring device in the battery compartment and a corresponding sensing and transmitting device. The battery compartment temperature sensing and monitoring device is configured to obtain real-time information on an internal temperature of the lithium-ion power battery compartment of the new energy vehicle, and determine whether a battery pack has an explosion risk through the temperature.

The battery compartment smoke detection module 370 in the explosion prevention and control unit 300 of the lithium-ion power battery of the new energy vehicle includes, but is not limited to an ion smoke detector, a photoelectric smoke detector, an infrared beam smoke detector, a video analytical smoke detector, a photosensitive fire detector, and a video analysis smoke detector and a corresponding sensing and transmitting device during specific construction.

The ion smoke detector, the photoelectric smoke detector, the infrared beam smoke detector, and the video analytical smoke detector is configured to obtain real-time information on the smoke condition inside the lithium-ion power battery compartment of the new energy vehicle, and determine whether the battery pack has the risk of fire, combustion, or explosion through the smoke condition.

The photosensitive fire detector and the video analysis smoke detector is configured to obtain real-time information on a flame condition inside the lithium-ion power battery compartment of the new energy vehicle, and determine whether the battery pack is at risk of fire, combustion, or explosion through the flame condition.

The battery explosion suppression module 380 in the explosion prevention and control unit 300 of the lithium-ion power battery of the new energy vehicle includes, but is not limited to a circuit controller and/or an intelligent circuit breaker and/or a lithium-ion battery compartment fire suppression device, and/or an automatic fire extinguishing linkage control device, and the like during specific construction.

The circuit controller is configured to receive circuit control information sent by the remote management unit forwarded by the on-board gateway unit, and cut off a power battery power supply line.

The intelligent circuit breaker is configured to automatically cut off the power battery power supply line when there is an explosion warning of the lithium-ion power battery of the new energy vehicle.

The lithium-ion battery compartment fire suppression device is configured to automatically spray and release a fire-extinguishing agent when an explosion warning of the lithium-ion power battery of the new energy vehicle occurs, and to suppress the fire of a lithium-ion power battery box.

The automatic fire extinguishing linkage control device is configured to spray a high-efficiency cooling suppressing medium when the explosion warning of the lithium-ion power battery of the new energy vehicle occurs, and to cool and suppress a thermal runaway cell.

The explosion prevention and control unit 300 of the lithium-ion power battery of the new energy vehicle constructed therefrom is preferably directly associated with the on-board gateway unit 400 during specific deployment, and is indirectly associated with the vehicle alarm prompt unit 500 and the remote management unit 600 through the on-board gateway unit 400. In this way, the plurality of sensing and transmitting devices of the cell temperature monitoring module, the cell deformation detection module, the cell air pressure monitoring module, the cell liquid leakage detection module, the battery compartment explosive gas detection module, the battery compartment ambient temperature monitoring module, and the battery compartment smoke detection module in the explosion prevention and control unit 300 of the lithium-ion power battery of the new energy vehicle converge the detection data to the data storage module of the on-board gateway unit through the network communication module of the on-board gateway unit, and perform an intelligent analysis through the edge computing module of the on-board gateway unit. When the detection analysis result of the corresponding detection object triggers an explosion warning of the lithium-ion power battery, the network communication module of the on-board gateway unit sends a corresponding acousto-optic alarm or a voice prompt to the alarm prompt unit, and at the same time uploads the alarm prompt information to the remote management unit through the network communication module of the on-board gateway unit.

FIG. 6 is a schematic diagram of a specific configuration principle and a network communication module of the on-board gateway unit in the vehicle safety monitoring system based on the Internet of Things according to this example.

Based on FIG. 6, the network communication module 410 in the on-board gateway unit 400 provided in this example is composed of a 5G communication device 411, a CAN bus communication device 412, a TCP/IP communication device 413, a Bluetooth communication device 414, and another wireless communication (Wi-Fi, UWB, Zigbee, and the like) device 415 and the like.

Based on FIG. 1 and FIG. 6, the network communication module 410 arranged in this way performs communication between the on-board gateway unit 400 and the remote management unit 600 through the 5G communication device 411.

The network communication module 410 can perform wired communication by using a CAN bus mode between the on-board gateway unit 400, the tire pressure real-time monitoring and warning unit 100, the vehicle overheat detection and warning unit 200, the explosion prevention and control unit 300 of a lithium-ion power battery of a new energy vehicle, and the alarm prompt unit 500 through the CAN bus communication device 412.

The network communication module 410 can perform wired communication by using a TCP/IP bus mode between the on-board gateway unit 400, the tire pressure real-time monitoring and warning unit 100, the vehicle overheat detection and warning unit 200, the explosion prevention and control unit 300 of a lithium-ion power battery of a new energy vehicle, the alarm prompt unit 500, and the remote management unit 600 through the TCP/IP communication device 413.

The network communication module 410 can perform wireless communication based on a Bluetooth protocol between the on-board gateway unit 400, the tire pressure real-time monitoring and warning unit 100, the vehicle overheat detection and warning unit 200, the explosion prevention and control unit 300 of a lithium-ion power battery of a new energy vehicle, and the alarm prompt unit 400 through the Bluetooth (Bluetooth) communication device 414.

The network communication module 410 can perform wireless communication based on a corresponding protocol such as Wi-Fi, UWB, Zigbee, and the like between the on-board gateway unit 400, the tire pressure real-time monitoring and warning unit 100, the vehicle overheat detection and warning unit 200, the explosion prevention and control unit 300 of a lithium-ion power battery of a new energy vehicle, and the alarm prompt unit 500 through another wireless communication (Wi-Fi, UWB, Zigbee, and the like) device 415.

Based on FIG. 6, the data storage module 420 in the on-board gateway unit 400 provided in this example includes a built-in data storage device and an external data storage device.

The built-in data storage device includes but is not limited to a built-in static random access memory SRAM, a built-in dynamic random access memory DRAM, and a built-in hard disk. The external data storage device includes, but is not limited to, an external mobile hard disk, a USB flash drive, a TF memory card, and a SD memory card.

The built-in data storage device and the external data storage device in the data storage module 420 may be configured to store information of the tire pressure real-time monitoring and warning unit, the vehicle overheat detection and warning unit, and the explosion prevention and control unit of the lithium-ion power battery of the new energy vehicle.

Based on FIG. 6, in the on-board gateway unit 400 provided in this example, the edge computing module 430 includes an AI intelligent chip with edge computing function and a terminal SDK with edge computing. The circuit board AI intelligent chip with an edge computing function and a terminal SDK with the edge computing function, and is configured to perform intelligent analysis and determination on the detection information uploaded by the tire pressure real-time monitoring and warning unit, the vehicle overheat detection and warning unit, and the explosion prevention and control unit of the lithium-ion power battery of the new energy vehicle.

The on-board gateway unit 400 constructed therefrom is preferably directly associated with the tire pressure real-time monitoring and warning unit 100, the vehicle overheat detection and warning unit 200, the explosion prevention and control unit 300 of the lithium-ion power battery of the new energy vehicle, the alarm prompt unit 500, and the remote management unit 600 unit during specific deployment.

In this way, when the on-board gateway unit receives the detection information of the tire pressure real-time monitoring and warning unit, the vehicle overheat detection and warning unit, and the explosion prevention and control unit of the lithium-ion power battery of the new energy vehicle, and analyzes and determines that a related warning alarm such as the tire low pressure, the vehicle overheat, or the lithium-ion power battery explosion is triggered, the on-board gateway unit sends the acousto-optic alarm or the voice prompt information to the alarm prompt unit and the real-time monitoring data information to the remote management unit; and
when the on-board gateway unit receives an alarm command, a voice prompt command, or an alarm threshold setting adjustment, or circuit control information sent by the remote management unit, the alarm command and the voice prompt command information are sent to the alarm prompt unit, and alarm threshold setting adjustment command information and circuit control command information are sent to the relevant detection device of the tire pressure real-time monitoring and warning unit, the vehicle overheat detection and warning unit, and the explosion prevention and control unit of the lithium-ion power battery of the new energy vehicle, to adjust an alarm threshold of a detection sensor and cut off a circuit of the power battery.

For the alarm prompt unit 500 provided in this example, it is preferable to directly associate the on-board gateway unit 400 during specific deployment, and is indirectly associated with the tire pressure real-time monitoring and warning unit 100, the vehicle overheat detection and warning unit 200, the explosion prevention and control unit 300 of the lithium-ion power battery of the new energy vehicle, and the remote management unit 600 through the on-board gateway unit.

In this way, when the local alarm prompt subunit receives the real-time monitoring and warning information of medium-risk or low-risk tire pressure sent by the on-board gateway unit, the vehicle overheat detection and warning formation, and the explosion warning information of the lithium-ion power battery of the new energy vehicle, the alarm prompt unit sends an internal cab acousto-optic alarm and the voice prompt to prompt the driver to stop nearby or stop immediately for inspection.

When the local alarm prompt subunit receives the high-risk level tire pressure real-time monitoring and warning information, the vehicle overheat detection and warning information, and the explosion warning information of the lithium-ion power battery of the new energy vehicle, the alarm prompt unit sends internal and external cab acousto-optic alarms and voice prompts to prompt the driver to stop immediately for inspection, prompt passers-by to be alert to an abnormal vehicle, avoid in time, or call the police immediately.

When the remote monitoring client software alarm prompt subunit receives real-time monitoring and warning information of medium-risk or low-risk tire pressure, the vehicle overheat detection and warning information, and the explosion warning information of the lithium-ion power battery of the new energy vehicle, the alarm prompt unit sends the alarm and prompt.

When the remote monitoring client software alarm prompt subunit receives the high-risk level tire pressure real-time monitoring and warning information, the vehicle overheat detection and warning information, and the explosion warning information of the lithium-ion power battery of the new energy vehicle, the alarm prompt unit sends the emergency alarm and the voice prompt and starts the emergency management process according to the emergency plan by default.

FIG. 9 is a schematic diagram of a composition principle of a government industry management client in a remote management unit of the vehicle safety monitoring system based on the Internet of Things according to this example.

As shown in FIG. 9, the government industry management client 610 of the remote management unit 600 provided in this example includes a public security industry management client software 611, a traffic industry management client software 612, an emergency industry management client software 613, and another industry management client software (such as an insurance industry management client software) 614 according to the different competent industry departments.

Based on FIG. 1, FIG. 8, and FIG. 9, the public security industry management client software 611 of the government industry management client 610 is configured to receive and display real-time monitoring and warning information of high-risk level tire pressure real-time monitoring and warning information, and explosion warning information of a lithium-ion power battery of a new energy vehicle forwarded by the tire pressure real-time monitoring and warning unit 100, the tire pressure real-time monitoring and warning unit 200, vehicle overheat detection and warning information, and the explosion prevention and control unit 300 of the lithium-ion power battery of the new energy vehicle through the on-board gateway unit 400 and the communication center 640, send a traffic management command to a road traffic police on duty at a location of a vehicle according to an information type, send a corresponding vehicle and location traffic accident handling command to a relevant traffic accident handler, and send 120 emergency rescue and another linkage management command according to the emergency plan setting.

The traffic industry management client software 612 of the government industry management client 610 is configured to receive and display real-time monitoring and warning information of high-risk level tire pressure real-time monitoring and warning information, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of the lithium-ion power battery of the new energy vehicle through the on-board gateway unit 400 and the communication center 640, send a management command to a relevant traffic safety responsible unit based on an information type, and send another linkage management information according to the emergency plan setting.

The emergency industry management client software 613 of the government industry management client 610 is configured to receive and display real-time monitoring and warning information of high-risk level tire pressure real-time monitoring and warning information, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of the lithium-ion power battery of the new energy vehicle through the on-board gateway unit 400 and the communication center 640, and send an emergency response command to a fire and other related emergency rescue personnel based on an information type, a vehicle type, a cargo loading type of a freight vehicle, and the like, and send another linkage management information according to the emergency plan setting.

Another industry management client software (such as an insurance industry management client software) 614 of the government industry management client 610 is configured to receive and display real-time monitoring and warning information of high-risk level tire pressure real-time monitoring and warning information, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of the lithium-ion power battery of the new energy vehicle through the on-board gateway unit 400 and the communication center 640, start an insurance claims service based on the information condition, and send another linkage management information according to the emergency plan setting.

It should be noted here that another industry management client software supports function customization based on the corresponding industry management needs or independently selects to open or close the relevant monitoring client function within a scope of user authority.

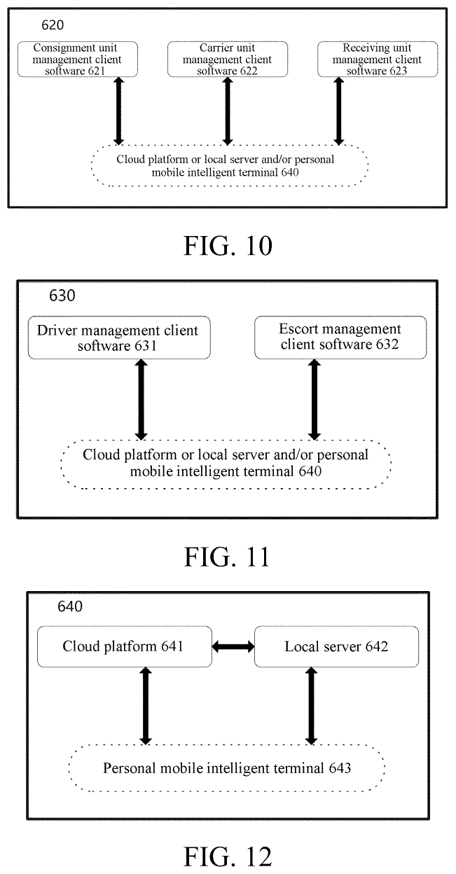

FIG. 10 is a schematic diagram of a composition principle of an enterprise operation management client 620 of a remote management unit 600 in the vehicle safety monitoring system based on the Internet of Things according to this example.

As shown in FIG. 10, the enterprise operation management client 620 of the remote management unit 600 provided in this example includes a consignment unit management client software 621, a carrier unit management client software 622, and a receiving unit management client software 623 depending on a user.

Based on FIG. 1, FIG. 8, and FIG. 10, the consignment unit management client software 621 in the enterprise operation management client 620 is configured to receive and display security tracking and inquiry information of a consignment vehicle.

The carrier unit management client software 622 in the enterprise operation management client 620 is configured to n receive and display tire pressure real-time monitoring and warning information, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of a lithium-ion power battery of a new energy vehicle through the on-board gateway unit 400 and the communication center 640. When the warning alarm information is received, emergency rescue guide information is sent to the driver and passenger service client 630 by a text, an image, a voice, a document, and the like. When a high-risk level warning alarm is received, emergency rescue guide information is sent to the driver and passenger service client 630 by a text, an image, a voice, a document, and the like, and a linkage alarm message is immediately sent to the government industry management client 610 synchronously based on the emergency plan setting.

The receiving unit management client software 623 in the enterprise operation management client 620 is configured to receive and display security tracking and inquiry information of a consignment vehicle.

FIG. 11 is a schematic diagram of a configuration principle of each driver and passenger service client in a remote management unit of the vehicle safety monitoring system based on the Internet of Things according to this example.

As shown in FIG. 11, the driver and passenger service client 630 of the remote management unit 600 provided in this example includes a driver management client software 631 and an escort management client software 632 depending on a user. A dangerous goods transport vehicle that needs to be escorted by personnel only have a driver management client software and an escort management client software.

Based on FIG. 1, FIG. 8, and FIG. 11, the driver management client software 631 in the driver and passenger service client 630 is configured to n receive and display tire pressure real-time monitoring and warning information, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of a lithium-ion power battery of a new energy vehicle through the on-board gateway unit 400 and the communication center 640, receive and display emergency rescue guide information sent by the carrier management client 622 by a text, an image, a voice, a document, and the like for an operating vehicle; the driver management client software supports voice broadcast warning information; and supports a feedback of a risk check condition and a handling result to the government industry management client 610 and the carrier management client 622 after the driver completes a risk check for the operating vehicle.

The escort service software 632 of the government industry management client 630 is configured to receive and display real-time monitoring and warning information of high-risk level tire pressure real-time monitoring and warning information, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of the lithium-ion power battery of the new energy vehicle through the on-board gateway unit 400 and the communication center 640; receive and display the emergency rescue guide information sent by the carrier management client 622 by a text, an image, a voice, a document, and the like for the operating vehicle, where the escort management client software here supports voice broadcast warning information; and support a feedback of a risk check condition and a handling result to the government industry management client 610 and the carrier management client 622 by an escort after the driver completes a risk check for the operating vehicle.

FIG. 12 is a schematic diagram of a composition principle of a communication center 640 of a remote management unit 600 in the vehicle safety monitoring system based on the Internet of Things according to this example.

Based on FIG. 12, the communication center 640 of the remote management unit 600 provided in this example includes a cloud platform 641, a local server 642, and a personal mobile intelligent terminal 643. This example encourages a communication center application mode of the cloud platform 641 combined with the personal mobile intelligent terminal 643, which can be determined according to an actual communication condition of a different user, and is not limited here.

Based on FIG. 1, FIG. 8, and FIG. 12, the cloud platform 641 in the communication center 640 is used for storage of data information and alarm information uploaded by the on-board gateway unit 400, and a shared data resource pool for data reception and invocation of the government industry management client software 610/the enterprise operation management client software 620/the driver and passenger service client software 630. The cloud platform is configured to support a computer hardware platform environment of the application of the government industry management client software 610/the enterprise operation management client software 620/the driver and passenger service client software 630, and used for communication interaction between the government industry management client software 610/the enterprise operation management client software 620/the driver and passenger service client software 630 and the on-board gateway unit 400. The cloud platform 641 is configured to communicate with the on-board gateway unit 400, receive and store real-time monitoring and warning information of the tire pressure, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of the lithium-ion power battery of the new energy vehicle through the on-board gateway unit 400, and forward the management command or the response command of the government industry management client software 610, the enterprise operation management client software 620, and the driver and passenger service client software 630 to the on-board gateway unit 400.

It should be noted here that the cloud platform supports a B/S monitoring client application, and the B/S monitoring client is preferably developed based on a latest version of a high-security operating system and a high-security browser (Xin Chuang version).

The local server 642 in the communication center 640 is used for storage of data information and alarm information uploaded by the on-board gateway unit 400, and a data resource pool for data reception and invocation of the government industry management client software 610/the enterprise operation management client software 620/the driver and passenger service client software 630, respectively. The cloud platform is configured to support a computer hardware platform environment of the application of the government industry management client software 610/the enterprise operation management client software 620/the driver and passenger service client software 630, and used for communication interaction between the government industry management client software 610/the enterprise operation management client software 620/the driver and passenger service client software 630 and the on-board gateway unit 400. The local server 642 is configured to communicate with the on-board gateway unit 400, receive and store real-time monitoring and warning information of the tire pressure, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of the lithium-ion power battery of the new energy vehicle through the on-board gateway unit 400, and forward the management command or the response command of the government industry management client software 610, the enterprise operation management client software 620, and the driver and passenger service client software 630 to the on-board gateway unit 400.

It should be noted here that the local server 642 supports a C/S monitoring client application, and the C/S monitoring client is preferably developed based on a latest version of various high-security operating systems of a Linux kernel.

The personal mobile intelligent terminal 643 in the communication center 640 is used for storage of data information and alarm information uploaded by the on-board gateway unit 400, an online query tool and temporary storage space for uploaded data information for the government industry management client APP software 610/the enterprise operation management client APP software 620/the driver and passenger service client APP software 630. The cloud platform is configured to support a computer hardware platform environment of the application of the government industry management client APP software 610/the enterprise operation management client APP software 620/the driver and passenger service client APP software 630, and used for communication interaction between the government industry management client APP software 610/the enterprise operation management client APP software 620/the driver and passenger service client APP software 630 and the on-board gateway unit 400. The personal mobile intelligent terminal 643 is configured to communicate with the on-board gateway unit 400 through the cloud platform 641 or the local server 642, receive and store real-time monitoring and warning information of the tire pressure, vehicle overheat detection and warning information, and explosion warning information of a lithium-ion power battery of a new energy vehicle forwarded by the tire pressure real-time monitoring and warning unit 100, the tire pressure real-time monitoring and warning unit 200, and the explosion prevention and control unit 300 of the lithium-ion power battery of the new energy vehicle through the on-board gateway unit 400, and forward the management command or the response command of the government industry management client APP software 610/the enterprise operation management client APP software 620/the driver and passenger service client APP software 630 to the on-board gateway unit 400.

It should be noted here that the mobile monitoring client APP is preferably developed based on the HarmonyOS microkernel or Android (Android) and another operating system based on the Linux kernel.

The remote management unit 600 formed therefrom is preferably arranged on a cloud platform of a competent government industry department related to vehicle traffic management or operation management and/or a local storage server and/or a personal handheld intelligent terminal of a relevant management personnel, a cloud platform and/or a local storage server and/or a personal handheld intelligent terminal of a relevant management personnel of a transportation enterprise and a transportation related party to which the vehicle belongs, and a personal handheld intelligent terminal of a driver and passenger during specific deployment, which is associated with the on-board gateway unit, and is indirectly associated with the tire pressure real-time monitoring and warning unit, the vehicle overheat detection and warning unit, the explosion prevention and control unit of a lithium-ion power battery of a new energy vehicle, and the alarm prompt unit through the on-board gateway unit.

The remote management unit 600 arranged in this way can receive the tire pressure real-time monitoring and warning information, the vehicle overheat detection and warning information, the explosion warning information of the lithium-ion power battery of the new energy vehicle and the related detection data information sent by the on-board gateway unit, and issue the driver management command based on the alarm information, feed back to the on-board gateway unit, and feed back to the alarm prompt unit through the on-board gateway unit. Meanwhile, the remote management unit supports setting and adjusting a warning threshold and an information upload frequency of the tire pressure real-time monitoring and warning unit, the tire pressure real-time monitoring and warning unit, and the relevant monitoring device of the explosion prevention and control unit of the lithium-ion power battery of the new energy vehicle through the relevant detection client software.

When the vehicle safety monitoring system 700 based on the Internet of Things formed by the solution of this example runs, it can first perform comprehensive real-time monitoring of the tire pressure of the vehicle, the overheating condition of the vehicle and/or the safety status of the lithium-ion power battery of the new energy vehicle, to achieve early detection and warning. In the process of warning, the acousto-optic alarm and the voice prompt the driver to check and handle in time. Through a battery explosion suppression module, the explosion warning and alarm condition of the power battery is automatically handled to prevent occurrences of a traffic safety accident and events such as vehicle spontaneous combustion and a vehicle explosion caused by a vehicle tire blowout, vehicle body overheat, and an explosion of the power battery.

Based on the above, the system can also be based on the constructed remote management unit, so that the vehicle safety monitoring information can be linked with the competent industry department and affiliated unit in real time, and the safety of various fuel vehicles and new energy vehicles can be improved through comprehensive detection of the vehicle safety element, and gain valuable golden handling time for an early deployment of emergency rescue and handling force and a rapid start of emergency rescue, which can prevent the consequences of traffic accident or the expansion of the consequences of vehicle spontaneous combustion and vehicle explosion accident, and ensure the safety of people's lives and property.

Finally, it should be noted that the above method of the present invention, or a specific system unit, or part of the unit, can be arranged on physical media, such as a hard disk, an optical disc, or any electronic device (such as a smart phone, a computer-readable storage media). When a machine loads and executes the program code (such as, a smart phone loads and executes), the machine becomes a device for performing the present invention. The above method and device of the present invention can also transmit a program code through some transmission media, such as a cable, an optical fiber, or any transmission mode. When the program code is received, loaded, and executed by the machine (such as the smart phone), the machine becomes a device for performing the present invention.

The basic principles, main features and advantages of the present invention have been shown and described above. Those skilled in the art should understand that the present invention is not limited by the above-mentioned embodiments. The foregoing embodiments and the description in the specification only illustrate the principle of the present invention. Without departing from the spirit and scope of the present invention, there will be various changes and improvements in the present invention, and these changes and improvements fall within the scope of the claimed invention. The scope of the claims of the present invention is defined by the appended claims and the equivalents.

What is claimed is:

1. A vehicle safety monitoring system based on the Internet of Things, comprising:
a tire pressure real-time monitoring and warning unit, wherein the tire pressure real-time monitoring and warning unit is associated with an on-board gateway unit and an alarm prompt unit and is associated with a remote management unit through the on-board gateway unit, and the tire pressure real-time monitoring and warning unit is configured to collect all information related to a tire pressure in real time, and based on the collected information, and analyze, directly or in cooperation with the on-board gateway unit, whether a tire leaks, a pressure in the tire, a temperature in the tire, and a risk warning;
a vehicle overheat detection and warning unit, wherein the vehicle overheat detection and warning unit is associated with the on-board gateway unit and is associated with the alarm prompt unit and the remote management unit through the on-board gateway unit, and the vehicle overheat detection and warning unit is configured to collect temperature information of a component directly related to a vehicle operating state on a current vehicle in real time, and determine, directly or in cooperation with the on-board gateway unit based on the collected information, whether the vehicle is overheated and a risk of explosion or damage exists;
an explosion prevention and control unit of a lithium-ion power battery of a new energy vehicle, wherein a sensor of the explosion prevention and control unit of the lithium-ion power battery of the new energy vehicle is arranged in a cell of the lithium-ion power battery of the new energy vehicle and in a battery compartment, is associated with the on-board gateway unit, and is associated with the alarm prompt unit and the remote management unit through the on-board gateway unit, and the explosion prevention and control unit of the lithium-ion power battery of the new energy vehicle is configured to collect a cell temperature, a cell deformation, a cell air pressure, a cell leakage condition, a battery compartment explosive gas concentration, a battery compartment ambient temperature, and a battery compartment smoke information of the current vehicle; and determine, through computing directly or in cooperation with the on-board gateway unit based on the collected information, whether there is an explosion risk or a combustion risk in a vehicle power battery, and enable a battery explosion suppression function when determining that a detection information analysis result is higher than a relevant set threshold to trigger a power cell danger or a battery compartment danger alarm;
an on-board gateway unit, wherein the on-board gateway unit is arranged in a vehicle cab, and is respectively associated with the tire pressure real-time monitoring and warning unit, the vehicle overheat detection and warning unit, the alarm prompt unit, and the remote management unit, and a communication channel is established among the units to complete data exchange, and the on-board gateway unit is further configured to complete, in cooperation with the tire pressure real-time monitoring and warning unit and/or the vehicle overheat detection and warning unit, risk warning processing based on the data collected by the corresponding unit;
an alarm prompt unit, wherein the alarm prompt unit is connected to the on-board gateway unit, and is configured to complete a local alarm on the vehicle and/or complete a remote alarm through the remote management unit associated with the on-board gateway unit; and
a remote management unit, wherein the remote management unit is deployed in a manner of multi-level linkage, is associated with the on-board gateway unit, and is indirectly associated with the tire pressure real-time monitoring and warning unit, the vehicle overheat detection and warning unit, and the alarm prompt unit through the on-board gateway unit, and is configured to receive a tire pressure alarm and/or a vehicle overheat alarm sent by the on-board gateway unit, and generate emergency response and emergency rescue management information according to requirements of an emergency plan when receiving a high-risk level alarm.

2. The vehicle safety monitoring system based on the Internet of Things according to claim 1, wherein
the tire pressure real-time monitoring and warning unit comprises a tire leakage detection module, a low tire pressure detection module, and a tire temperature monitoring module; and
the tire leakage detection module comprises a tire valve core leakage detection device, a tire pinhole leakage detection device, a tire foreign object detection device, a tire side and inner edge damage detection device, a hub flange deformation detection device, a hub fracture detection device, and sensing and transmitting devices corresponding to the hub fracture detection device, and is configured to obtain real-time information about whether there is air leakage condition in each tire of the vehicle, and transmit the obtained information to the on-board gateway unit or to the remote management unit through the on-board gateway unit, wherein the tire valve core leakage detection device is configured to collect airflow information near a tire valve core, the tire pinhole leakage detection device is configured to detect whether there is slow air leakage caused by a pinhole on a tire surface, the tire foreign object detection device is configured to monitor whether a foreign object that is likely to cause tire leakage punctures the tire, the tire side and inner edge damage detection device is configured to monitor whether a side and an inner edge of the tire are damaged, the hub flange deformation detection device is configured to monitor a deformation state of a hub flange, and the hub fracture detection device is configured to monitor whether a vehicle hub bursts; and
the low tire pressure detection module comprises a direct tire pressure monitoring device and an indirect tire pressure monitoring device and sensing and transmitting devices corresponding to the direct tire pressure monitoring device and the indirect tire pressure monitoring device, and is configured to obtain real-time information of an air pressure condition of each tire of the vehicle, and transmit the obtained information to the on-board gateway unit or to the remote management unit through the on-board gateway unit, wherein the low tire pressure detection module of the tire pressure real-time monitoring and warning unit, the direct tire pressure monitoring device is configured to directly collect real-time pressure value information in the tire, and the indirect tire pressure monitoring device is configured to collect a real-time speed difference of different tires of the vehicle, and determine consistency of rolling radii of wheels through the speed difference, so as to determine whether a tire is in a low-pressure state; and
the tire temperature monitoring module comprises a temperature sensing and monitoring device in each tire and a corresponding sensing and transmitting device, and is configured to obtain real-time information of an internal temperature condition of each tire of the vehicle, and transmit the obtained information to the on-board gateway unit or to the remote management unit through the on-board gateway unit.

3. The vehicle safety monitoring system based on the Internet of Things according to claim 1, wherein
the vehicle overheat detection and warning unit comprises an engine/motor temperature monitoring module, a differential lock system temperature monitoring module, a tire temperature monitoring module, and/or an exhaust pipe temperature monitoring module, and is directly related to the on-board gateway unit, all temperature detection devices of the engine/motor temperature monitoring module, the differential lock system temperature monitoring module, the tire temperature monitoring module, and/or the exhaust pipe temperature monitoring module are configured to assemble the detection data to the on-board gateway unit, and perform intelligent analysis through the on-board gateway unit, and when a temperature analysis result of a corresponding detected object triggers the vehicle overheat detection and warning, the on-board gateway unit sends a corresponding alarm and prompt to the alarm prompt unit through the on-board gateway unit, and uploads the alarm prompt information to the remote management unit through the on-board gateway unit;
the engine/motor temperature monitoring module is configured to obtain real-time temperature information of a vehicle engine/motor, and transmit the obtained information to the on-board gateway unit or to the remote management unit through the on-board gateway unit;
the differential lock system temperature monitoring module is configured to obtain real-time temperature information of a vehicle differential lock system, and transmit the obtained information to the on-board gateway unit or to the remote management unit through the on-board gateway unit;
the tire temperature monitoring module is configured to obtain real-time temperature information of a vehicle tire, and transmit the obtained information to the on-board gateway unit or to the remote management unit through the on-board gateway unit; and
the exhaust pipe temperature monitoring module is configured to obtain real-time temperature information of an exhaust pipe of a fuel vehicle, and transmit the obtained information to the on-board gateway unit or to the remote management unit through the on-board gateway unit.

4. The vehicle safety monitoring system based on the Internet of Things according to claim 1, wherein
the explosion prevention and control unit of the lithium-ion power battery of the new energy vehicle comprises one or more of a cell temperature monitoring module, a cell deformation detection module, a cell air pressure monitoring module, a cell liquid leakage detection module, a battery compartment explosive gas detection module, a battery compartment ambient temperature monitoring module, a battery compartment smoke detection module, and a battery explosion suppression module, is directly related to the on-board gateway unit to monitor the cell temperature, the cell deformation, the cell air pressure, the liquid leakage condition, the battery compartment explosive gas concentration, the battery compartment ambient temperature, and the battery compartment smoke condition in real time, warning information is sent when the detection result is higher than a set threshold or the leakage occurs, when a medium or low risk warning is triggered, a local warning acousto-optic or voice prompt is sent through the alarm prompt unit while the warning information is sent to the remote management unit, and when a high risk warning is triggered, an explosion suppression device is automatically started, and the local warning acousto-optic or voice prompt is sent through the alarm prompt unit while the warning information is sent to the remote management unit;
the cell temperature monitoring module comprises an internal cell temperature sensing and monitoring device and/or an internal cell resistance tomography device and a corresponding sensing and transmitting device, and is configured to obtain real-time cell temperature information of the vehicle power battery, and transmit the obtained information to the on-board gateway unit or to the remote management unit through the on-board gateway unit;
the cell deformation detection module comprises an internal deformation sensing and detection device and/or a cell surface variable resistance detection device and a corresponding sensing and transmitting device, and is configured to obtain real-time cell deformation information of the vehicle power battery, and transmit the obtained information to the on-board gateway unit or to the remote management unit through the on-board gateway unit;
the cell air pressure monitoring module is configured to obtain real-time cell air pressure information of the vehicle power battery, and transmit the obtained information to the on-board gateway unit or to the remote management unit through the on-board gateway unit;
the cell liquid leakage detection module comprises a battery bus insulation impedance detection device and/or a battery positive and negative bus current detection device and/or a VOC detection device and a corresponding sensing and transmitting device, and is configured to obtain real-time cell leakage information of the vehicle power battery, and transmit the obtained information to the on-board gateway unit or to the remote management unit through the on-board gateway unit;
the battery compartment explosive gas detection module comprises one or more of a CO explosive gas detection, sensing, and detection device, an H₂ explosive gas detection, sensing, and detection device, a CH₄ explosive gas detection, sensing, and detection device, a VOC detection device, and a corresponding sensing and transmitting device, and is configured to obtain composition and real-time concentration information of an explosive gas in a vehicle power battery compartment, and transmit the obtained information to the on-board gateway unit or to the remote management unit through the on-board gateway unit;
the battery compartment ambient temperature monitoring module is configured to obtain ambient temperature information of the vehicle power battery compartment, and transmit the obtained information to the on-board gateway unit or to the remote management unit through the on-board gateway unit;
the battery compartment smoke detection module comprises one or more of an ion smoke detector, a photoelectric smoke detector, an infrared beam smoke detector, a video analytical smoke detector, a photosensitive fire detector, and a video analysis smoke detector and a corresponding sensing and transmitting device, and is configured to obtain information about whether there is smoke in the vehicle power battery compartment, and transmit the obtained information to the on-board gateway unit or to the remote management unit through the on-board gateway unit; and
the battery explosion suppression module of the battery compartment comprises a circuit controller and/or an intelligent circuit breaker and/or a lithium-ion battery compartment fire suppression device and/or an automatic fire extinguishing linkage control device, and is configured to cut off the power supply or perform fire extinguishing and explosion-proof treatment when explosion warning information of the lithium-ion power battery is received.

5. The vehicle safety monitoring system based on the Internet of Things according to claim 1, wherein
the on-board gateway unit comprises a network communication module and/or a data storage module, and/or an edge computing module;
the network communication module comprises one or more of a 5G communication device, a CAN bus communication device, a TCP/IP communication device, a Bluetooth communication device, and another wireless communication device, and is configured for data exchange among the tire pressure real-time monitoring and warning unit, the vehicle overheat detection and warning unit, the explosion prevention and control unit of the lithium-ion power battery of the new energy vehicle, the alarm prompt unit, and the remote management unit;
the data storage module comprises a built-in data storage device and an external data storage device, and is configured to store detection information uploaded by the tire pressure real-time monitoring and warning unit, the vehicle overheat detection and warning unit, or the explosion prevention and control unit of the lithium-ion power battery of the new energy vehicle; and
the edge computing module comprises an AI smart chip with an edge computing function and a terminal SDK with the edge computing function, and is configured to perform intelligent analysis and determination on the detection information uploaded by the tire pressure real-time monitoring and warning unit, the vehicle overheat detection and warning unit, or the explosion prevention and control unit of the lithium-ion power battery of the new energy vehicle.

6. The vehicle safety monitoring system based on the Internet of Things according to claim 1, wherein
the on-board gateway unit is directly associated with the tire pressure real-time monitoring and warning unit, the vehicle overheat detection and warning unit, the explosion prevention and control unit of the lithium-ion power battery of the new energy vehicle, the alarm prompt unit, and the remote management unit;
when the on-board gateway unit receives the detection information of the tire pressure real-time monitoring and warning unit, the vehicle overheat detection and warning unit, and the explosion prevention and control unit of the lithium-ion power battery of the new energy vehicle, and analyzes and determines that a related warning alarm such as the tire low pressure, the vehicle overheat, or the lithium-ion power battery explosion is triggered, the on-board gateway unit sends an alarm command to the alarm prompt unit and sends warning and alarm information and real-time monitoring data information to the remote management unit; and
when the on-board gateway unit receives an alarm command, a voice prompt command, or an alarm threshold setting adjustment, or circuit control information sent by the remote management unit, the alarm command and the voice prompt command information are sent to the alarm prompt unit, and alarm threshold setting adjustment command information and circuit control command information are sent to the relevant detection device of the tire pressure real-time monitoring and warning unit, the vehicle overheat detection and warning unit, and the explosion prevention and control unit of the lithium-ion power battery of the new energy vehicle, to adjust an alarm threshold of a detection sensor and cut off a circuit of the power battery.

7. The vehicle safety monitoring system based on the Internet of Things according to claim 1, wherein
the alarm prompt unit comprises a vehicle local alarm prompt subunit and a remote monitoring client software alarm prompt subunit.

8. The vehicle safety monitoring system based on the Internet of Things according to claim 1, wherein
the remote management unit comprises a government industry management client software and/or an enterprise operation management client software, a driver and passenger service client software, and a communication center;
the government industry management client software is configured to receive and display high-risk level tire pressure real-time monitoring and warning information, vehicle overheat detection and warning information, and explosion warning information of the lithium-ion power battery of the new energy vehicle forwarded by the tire pressure real-time monitoring and warning unit, the tire pressure real-time monitoring and warning unit, and the explosion prevention and control unit of the lithium-ion power battery of the new energy vehicle through the on-board gateway unit and the communication center, send a relevant management command based on the received warning and alarm information, start an emergency management process, and issue a relevant emergency response command;
the enterprise operation management client software is configured to: receive and display tire pressure real-time monitoring and warning information, vehicle overheat detection and warning information, and explosion warning information of the lithium-ion power battery of the new energy vehicle forwarded by the tire pressure real-time monitoring and warning unit, the tire pressure real-time monitoring and warning unit, and the explosion prevention and control unit of the lithium-ion power battery of the new energy vehicle through the on-board gateway unit and the communication center, send a relevant management command based on the received warning and alarm information, start the emergency management process, send an emergency alarm to a government industry management client, and issue a relevant emergency response command when high-risk level tire pressure real-time monitoring and warning information, the vehicle overheat detection and warning information, and the explosion warning information of the lithium-ion power battery of the new energy vehicle are received;
the driver and passenger service client software is configured to: receive and display tire pressure real-time monitoring and warning information, vehicle overheat detection and warning information, and explosion warning information of the lithium-ion power battery of the new energy vehicle forwarded by the tire pressure real-time monitoring and warning unit, the tire pressure real-time monitoring and warning unit, and the explosion prevention and control unit of the lithium-ion power battery of the new energy vehicle through the on-board gateway unit and the communication center, send an acousto-optic alarm, a voice prompt, and an emergency rescue guide corresponding to alarm and warning information based on the received alarm and warning information, to prompt the driver to stop nearby or stop immediately for inspection, and provide a corresponding emergency response guide; and
the communication center is configured to communicate with the on-board gateway unit, receive and store the tire pressure real-time monitoring and warning information, the vehicle overheat detection and warning information, and the explosion warning information of the lithium-ion power battery of the new energy vehicle forwarded by the tire pressure real-time monitoring and warning unit, the tire pressure real-time monitoring and warning unit, and the explosion prevention and control unit of the lithium-ion power battery of the new energy vehicle through the on-board gateway unit, and forward the information to the government industry management client software, the enterprise operation management client software, and the driver and passenger service client software respectively, and the communication center also serves as a computer system environment for the government industry management client software, the enterprise operation management client software, and the driver and passenger service client software, and is configured to support a related software application, and forward management commands or response commands of the government industry management client software, the enterprise operation management client software, and the driver and passenger service client software to the on-board gateway unit.

9. The vehicle safety monitoring system based on the Internet of Things according to claim 1, wherein
the remote management unit is arranged on a cloud platform of a competent government industry department related to vehicle traffic management or operation management and/or a local storage server and/or a personal hand-held intelligent terminal of a relevant management person, a cloud platform and/or a local storage server of a transport enterprise to which the vehicle belongs and transport-related parties and/or a personal hand-held intelligent terminal of a relevant management person, and a personal hand-held intelligent terminal of a driver and passenger, is associated with the on-board gateway unit, and is indirectly associated with the tire pressure real-time monitoring and warning unit, the vehicle overheat detection and warning unit, the explosion prevention and control unit of the lithium-ion power battery of the new energy vehicle, and the alarm prompt unit through the on-board gateway unit.

10. The vehicle safety monitoring system based on the Internet of Things according to claim 8, wherein
the on-board gateway unit is directly associated with the tire pressure real-time monitoring and warning unit, the vehicle overheat detection and warning unit, the explosion prevention and control unit of the lithium-ion power battery of the new energy vehicle, the alarm prompt unit, and the remote management unit;
when the on-board gateway unit receives the detection information of the tire pressure real-time monitoring and warning unit, the vehicle overheat detection and warning unit, and the explosion prevention and control unit of the lithium-ion power battery of the new energy vehicle, and analyzes and determines that a related warning alarm such as the tire low pressure, the vehicle overheat, or the lithium-ion power battery explosion is triggered, the on-board gateway unit sends an alarm command to the alarm prompt unit and sends warning and alarm information and real-time monitoring data information to the remote management unit; and
when the on-board gateway unit receives an alarm command, a voice prompt command, or an alarm threshold setting adjustment, or circuit control information sent by the remote management unit, the alarm command and the voice prompt command information are sent to the alarm prompt unit, and alarm threshold setting adjustment command information and circuit control command information are sent to the relevant detection device of the tire pressure real-time monitoring and warning unit, the vehicle overheat detection and warning unit, and the explosion prevention and control unit of the lithium-ion power battery of the new energy vehicle, to adjust an alarm threshold of a detection sensor and cut off a circuit of the power battery.

11. The vehicle safety monitoring system based on the Internet of Things according to claim 8, wherein
the remote management unit is arranged on a cloud platform of a competent government industry department related to vehicle traffic management or operation management and/or a local storage server and/or a personal hand-held intelligent terminal of a relevant management person, a cloud platform and/or a local storage server of a transport enterprise to which the vehicle belongs and transport-related parties and/or a personal hand-held intelligent terminal of a relevant management person, and a personal hand-held intelligent terminal of a driver and passenger, is associated with the on-board gateway unit, and is indirectly associated with the tire pressure real-time monitoring and warning unit, the vehicle overheat detection and warning unit, the explosion prevention and control unit of the lithium-ion power battery of the new energy vehicle, and the alarm prompt unit through the on-board gateway unit.
